(19) United States
(12) Patent Application Publication
(10) Pub. No.: US 2010/0137144 A1
(43) Pub. Date: Jun. 3, 2010

(54) METHOD AND MEANS FOR DETECTING AND/OR QUANTIFYING HIERARCHICAL MOLECULAR CHANGE OF A CELL IN RESPONSE TO AN EXTERNAL STIMULUS

(75) Inventors: Jose Remacle, Malonne (BE); Vincent Bertholet, Jambes (BE); Sylvain Margaine, Anderlecht (BE); Francoise Delongueville, Natoye (BE); Christophe Van Huffel, Watermael-Boitsfort (BE); Veronique Mainfroid, Waremme (BE); Christelle Plennevaux, St. Gerard (BE)

Correspondence Address: KNOBBE MARTENS OLSON & BEAR LLP, 2040 MAIN STREET, FOURTEENTH FLOOR, IRVINE, CA, 92614, US

(73) Assignee: Eppendorf Array Technologies S.A., Namur (BE)

(21) Appl. No.: 11/917,042

(22) PCT Filed: Jun. 23, 2006
(86) PCT No.: PCT/BE2006/000071

§ 371 Date: Dec. 10, 2007

(30) Foreign Application Priority Data
Jun. 24, 2005 (EP) 05447148.7

(51) Int. Cl. C40B 30/00; C40B 60/12

(52) U.S. Cl. 506/7; 506/39

(57) ABSTRACT

The present invention is related to a method for detecting and/or quantifying hierarchical (regulated) molecular changes of a cell in response to any external stimulus.

### FIELD OF THE INVENTION

The present invention is related to a method for detecting and/or quantifying hierarchical (regulated) molecular change of a cell in response to an external biological, physical and/or chemical stimulus.

The present invention is also related to the kit (including kit of parts) comprising the various media and means for performing the steps of said method.

The present invention is also related to the computer system for performing specific steps of the method according to the invention.

A last aspect of the present invention is related to an apparatus, possibly an automate, for performing the various steps of the method according to the invention and possibly integrating the computer system according to the invention.

### BACKGROUND OF THE INVENTION

The study of complex living systems like the reactions and adaptation occurring within cells is difficult because of the high complexity of the cell, the involvement of large number of cell components, the various levels of regulation with interconnected relationships between these components and the very low amount of material usually available for the analysis. The assays for multiple components are now performed on a miniaturization scale by genomic studies for the expressed genes and by proteomic for proteins.

Indeed, any stimulus applied upon the cell requires a fast and adapted response by target cells which is mediated through different regulatory levels before being translated into mRNA and protein synthesis. One of the main common cell response is achieved through the stimulation of transduction cascades mostly through receptors activation, which relay at the intracellular level the extra cellular signals sensed by the cells. On the other side fast activation is based on modifications of pre-existing proteins. Transduction cascades culminate in the activation of transcription factors (TFs) which constitute a particularly important class of proteins, as they make the junction between proteomics and genomics due on one side to their direct activation by signaling cascades and on the other side to the regulation of genes which are under their control. Gene expression is a later event, which is assessed by different methods being part of the genomic in its broad sense. Genes are then translated into proteins which are then processed by a series of post-translational modifications; the study of proteins and their modification being part of the proteomic analysis.

Understanding the whole process of cell biology requires the concerted analysis of all regulation levels, and their spatiotemporal integration, as they are linked to each other by a complex network of interactions with some positive or negative feedback occurring at different levels involving different cell compartments and having different time frames after a given stimulus or external input. This multilevel analysis is necessary to understand the cell response, as a single transduction cascade can be activated by a multitude of stimuli or stresses, and since a same stress can lead to the parallel activation of many cascades that are either interconnected, parallel each other and even compensate for one another. Similarly, the same transcription factors can differentially regulate several genes, with an overall effect positive, negative, or even hardly detectable, depending on the gene and the presence of other transcriptional factors.

### STATE OF THE ART

Understanding biology as an overall well structured and regulated system requires examining the structure and dynamics of cellular function, rather than the characteristics of isolated parts of a cell. Identification of gene-regulatory networks is a major challenge.

Genomic and proteomic approaches for a global analysis of cell signaling have been described (Zhu and Snyder 2002, Current Opinion in Cell Biology, 14, 173-179). The US 2004/0096815 and US 2004/0096816 also compared proteomic and transcriptomic analysis for identifying a biological parameter which is modified following a stress or further to study cell aging.

One of the most powerful methods for analysing a specific cellular response to a situation such as a stimulus is the use of DNA microarray technology to analyse multiple gene expression (Schena et al. 1995, Science, 270, 467-470). The ability to analyse many transcripts simultaneously provides a detailed molecular phenotype, which can be used to deduce the different subsets of responses affected upon activation or inactivation of a signaling pathways.

Although DNA microarray technologies have proven to be very powerful in analysing protein function and pathways, gene function is manifested by the activity of its protein product. Therefore, analysis of proteins is expected to be more informative for dissecting protein function and pathways. This is particularly true for signaling pathways, because many pathways mediate their effects through post-translational modification such as protein phosphorylation. Innovative approaches, including yeast two-hybrid, two-dimensional gel/mass spectrometry and protein microarray methods have emerged recently for the large-scale analysis of protein signaling pathways. Protein microarrays are generally antibody arrays in which antibodies directed against different proteins or epitopes are spotted onto a slide. Beside protein arrays, the most widely used proteomic analytical method is the separation of the proteins in 2D gel and the identification of the individual proteins based on their molecular weight or their particular sequences using mass spectroscopy.

Despite the obvious attraction of parallel profiling of transcripts and proteins on a global ‘omic’ scale, there are differences involved in their performance and their biological signification. “Transcriptomics” is now a robust technology capable of simultaneously quantifying hundreds or thousands of defined mRNA species in a miniaturized format. Conversely, proteomic analysis is currently much more limited in breadth and depth of coverage owing to variation in protein abundance, hydrophobicity, stability, size and charge.

Modeling the transcriptomic or proteomic multiparametric data has been proposed on one level of analysis mainly the interconnection of expressed genes or proteins according to their function and involvement in a biological situation. This new modeling is referred as system biology (Barabasi and Oltvai, 2004, Nature Reviews Genetics, 5, 21-33. It also includes some knowledge of the possible regulatory pathways but not performed on the same cell. So there is a need for method and means for performing multiparametric molecular assays on a cell at different levels of regulation and to integrate the data of a cell into a hierarchical view of a cell regulation.

Kawahara Nobutaka et al (journal of cerebral blood flow and metabolism, 24, 212-223, 2004) describe global change in the expression level of mRNA following Ischemia using an oligonucleotide-based DNA microarray. This article only provides experimental data regarding gene expression level.

Roberts et al (Science, 287, 873-880, 2000) describe a DNA microarray analysis of changes in gene expression underlying pheromone signaling in yeast. This transcript profiling was obtained upon a two-dimensional, hierarchical cluster matrix made of the most highly regulated genes. Similarly to the previous paper, the analysis is only based on experimental data obtained from the expression of genes following a stimulus.

The European patent application EP-1 491 894 describes a method for the evaluation of the activation state of cells through the determination of the equilibrium between the activities of kinase/phosphate enzymes on proteins participating in signal transduction into cells or determining the level of phosphorylation of cellular proteins participating in signal transduction into cells.

Quian Jiang et al (Bioinformatics, 19, 1917-1926, 2003) describe a prediction of regulatory network by genome-wide identification of transcription factor targets from gene expression data.

Zhu Heng et al (current opinion in cell biology, 14, 173-179, 2002), review genomic and proteomic approaches for the global analysis of cell signaling, including DNA microarray expression profiling and protein microarrays.

### SUMMARY OF THE INVENTION

The aim of the present invention is to provide a solution to the comprehension of a cell in a particular situation as being a highly complex regulated system.

Until now, it was not possible to obtain a precise view of all possible interactions of the relationships (at defined time periods) between the different cell levels of regulation and the consequences of such regulation on the transcriptome and proteome of the cell submitted to a particular stimulus.

The invention proposes a solution to this problem and is related to a method and means to characterize (for the detection and/or quantification of)a hierarchical (regulated) molecular change of a cell in response to any external stimulus by integrating at least two levels (a first level and a second level) of cell function, the molecules involved in the first level being regulatory molecules interacting with the expression of the molecules of the second level, by the following steps:
a) obtaining (possibly after a time interval following the stimulus (after 15 minutes, 1 hour, 24 hours, . . . )) a cell extract from the cell (submitted to the stimulus) following the stimulus;
b) detecting and/or quantifying a molecular (cell) change at a first level of the cell function by submitting the cell extract at the selected time interval to a first assay upon microarray, said first assay capable of obtaining (comprising) the steps of:
   a detection and/or a quantification of at least 5, 10, 15, 20 or 50 different activated transcriptional factors (TF) present in the cell extract and/or,
   a detection and/or a quantification of at least 5, 10, 15, 20 or 50 different activated kinases, including quantification of kinase activity;
c) detecting and/or quantifying a molecular (cell) change at a second level of a cell function, by submitting the same cell extract to a second assay upon microarray, said second assay comprising: 20, 50, 100, 200, 500 or 1000
d) a detection and/or a quantification of at least 10, 20, 50, 100, 200, 500 or 1000
   different expressed genes and/or,
e) a detection and/or a quantification of at least 10, 20, 50, 100, 200, 500 or 1000
   different corresponding proteins encoded by these expressed genes, wherein the expressed genes and the corresponding synthesized proteins are regulated by the activated transcriptional factors and kinases of the first level of the cell function;
f) collecting the results of the detection and/or the quantification of the expressed genes and/or synthesized proteins and the results of the detection and/or the quantification of the activated transcriptional factors and/or activated kinases;
g) correlating the (collected) results of the detection and/or the quantification of the expressed genes and/or synthesized proteins to the (collected) results of the detection and/or the quantification of the activated transcriptional factors and/or activated kinases;
h) integrating the (collected) results of said detection and/or quantification and their correlation in a model of (regulated) hierarchical molecular change, preferably by a computer and possibly,
i) characterizing (preferably by a computer) the hierarchical (regulated) molecular changes in the cell resulting from the external biological, physical and/or chemical stimulus that provides the functional links between the molecular change of the cell detected and/or quantified in the first level and second level possibly at different time.

By applying the method according to the invention, it is possible to obtain from a bioassay detection a clear view of the different molecular changes in a cell in response to the external stimulus. These molecular changes are hierarchical, which means that is possible to obtain links between molecule expressed or repressed in the first and second level following the specific stimulus applied d upon the cell.

The present invention is also related to means and media for obtaining this detection, such as a kit or kit of parts or device (including a computer) comprising means and media for performing the detection and/or quantification method steps.

The present invention also concerns the kit or device comprising a computer program collecting and integrating the results of this detection and/or quantification and their correlation, and possibly for characterizing hierarchical (regulated) molecular change in a cell (preferably resulting from the stimulus). This computer program (product) could also be used for characterizing the relationships between the different levels of regulation occurring in the cell, and for providing to the experimenter, information regarding these various interactions.

The present invention allows the identification of the regulatory mechanisms which take place in a cell in a given situation and the changes that they induce on cell components such as the genes or the proteins. These cellular changes are hierarchical, as they occur on the different cell components in a spatio-temporal manner. When subjected to a given stimulus, cells must indeed respond in a fast and adapted fashion, where early events such as kinases phosphorylation and transcription factors activation precede—and give rise to—later events such as regulated gene expression. Hence, these early and late events are considered as different levels (the first level, the second level, . . . ) of regulation, as they are interconnected but cannot take place simultaneously.

Unraveling the regulatory mechanisms which are activated in a cell comprises obtaining experimental data at different levels of regulation and determining the cause/effect relationships taking into account the general available knowledge about the cellular components and preferably the input from published data present in the data base(s).

Collecting experimental data at different levels of regulation of a cell is an absolute requirement, as the regulation is a process which highly depends on the cellular context. Indeed, pathways of regulation are presented in a general way and interactions between genes or proteins are also described in a broad sense. But it is virtually impossible to associate a priori the change of one gene or one protein to one regulatory pathway since the level of expression of a gene or the level of production of the corresponding protein in a cell is the result of regulatory processes which may have contradictory effects, some having a positive effect and others having negative effects on this level. Therefore, pathways are presented in a general broad manner and are the compilation of results obtained on several cell types and in different biological conditions or contexts. They are an average compromise that can rarely be transposed “as is” to a specific cell study. So it is impossible to obtain a picture (a view) or a model of the regulatory process to explain the level of gene expression or protein production in a given cell (after a specific delay following the stimulus) from a theoretical model. Furthermore, the regulatory processes involve enzymes, such as kinases (preferably MAP-kinases) and phosphatases, whose activity not only depends on the amount of enzyme molecules present inside the cell, but also on post-translational modifications including subunits association/dissociation, interaction with regulatory proteins, phosphorylation/dephosphorylation events or the presence of activator/inhibitors or effectors.

Within one regulatory process, the outcome result is impossible to predict a priori. For example, the transcription of genes is under the control of transcription factors acting on specific sequences in their promoter part. A theoretical analysis of the promoter sequences allows the detection of all the consensus sequences for the possible binding of the transcription factors. Such theoretical analysis however shows that there are many possible transcription factor binding sites for a given gene. In vivo, however, not all binding sites are accessible to the corresponding transcription factors, as i.e. some are masked by the chromatin structure. Moreover, the binding of a transcription factor to its target sequence can have a positive or negative effect on the transcription, depending on the cellular context. Also, the binding of one transcription factor can hamper the binding of another one, thus making the prediction of the final outcome very difficult or even impossible given the number of possible combinations of transcription factors present in a cell. One transcription factor is active or non active according to his post-translation modification being mostly the phosphorylation of some of its amino-acids, with some having a activating and some others an inhibitory effect. Moreover transcription factors are very often part of a family and they are composed of subunits that can vary from one cell to the other and from one situation to the other. Besides the activation of transcription factors, other players can also affect the transcriptional level of the genes, such as the presence of miRNA or siRNA acting as inhibitors of the translation and the stability of the mRNA.

Data base searches will therefore propose all known solutions which have been reported as adopted by cells following a given stimulation. But a particular cell will only adopt some of these responses which are very specific to the context in (hierarchical (regulated) molecular cell changes) which the stimulation took place. Moreover, as data bases are always expending, and are per definition never complete, they may not contain some or all of the solutions actually adopted by the studied cells in the studied context. Conversely, establishing a regulation model on the sole basis of experimental data will always limit the output information to the experimental content. For all these reasons, predicting the effect of a stimulus on the regulation of a cell requires establishing an interaction model which will integrate experimental knowledge and data base inputs. The construction of such a model with all its complexity is preferably performed by using computer software and represents the basis of the invention.

The invention also provides means to test(by the method of the invention)precise effect of a compound or a drug in a given biological cell, tissue, organism and the identification of a possible target, among multiple regulatory targets, playing a role in said cell, tissue, organism being related to a specific pathology.

The present invention will be described in more details in the following examples, in reference to the enclosed figures presented as non-limiting illustrations of the various embodiments of the present invention.

### SHORT DESCRIPTION OF THE FIGURES AND TABLES

FIG. 1 is a schematic representation of a preferred method of the invention. The figure depicts a flowchart of results and information obtained on arrays and their input for the optionally predictive method performed by an executable program: input of data from 2 levels of cell functions, the first level (step B) being a regulatory biological process of the second level (step C). The first analysis step (step D) comprises independent analysis of the input data and optional input from database 1 for first level data and optional input from database 3 for second level data. Input data may be generated from different time periods. These optional database input are pathways, genes annotations, genes networks. In a second step, data analysis from the two levels are correlated (step E) and a model response is constructed (step F) as a representation of interactions between the 2 levels using optional complementary information drawn from database 2 containing for example validated relational models or general information on the relationships between the two levels. The resulting constructed model feeds database 2 for further predictive analysis. Finally, the output data are the functional links between molecular change of the cell detected and/or quantified in the first level and second level (step G).

FIG. 2 is a schematic representation of possible hierarchical (regulated) changes in a cell in response to an external stimulus. The model integrates at least a first level of cell function and a second level of cell function, the molecules involved in the first level (cytokines, receptors, kinases, transcription factors, miRNAs) being regulatory molecules interacting with the expression of the molecules of the second level (gene expression, proteins).

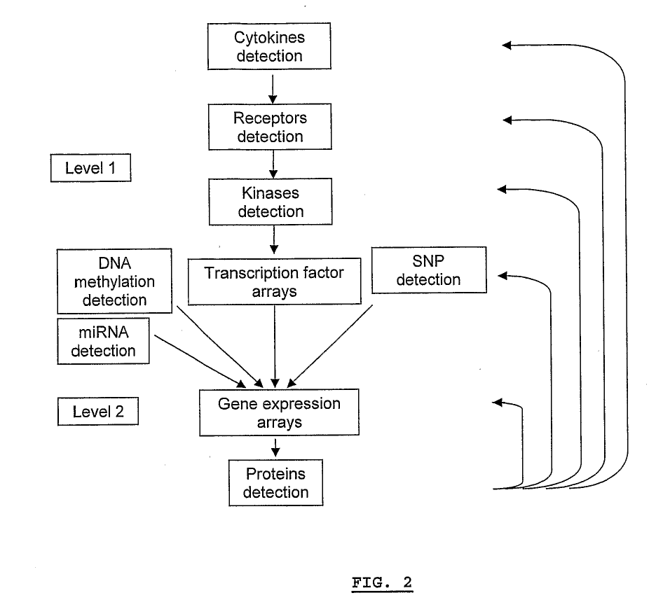

FIG. 3 shows the profile of activated transcription factors in U937 cells stimulated with interferon γ for 15 min (A) and 24 h (B) as described in examples 1 and 2. Unstimulated cells are used as control. The assay was performed on a TF Chip capable of detecting 8 different transcription factors.

FIG. 4 shows the profile of activated transcription factors in U937 cells stimulated with interferon α (A) and γ (B) for 15 min as described in example 3. Unstimulated cells are used as control.

FIG. 5 shows the profile of activated transcription factors in MCF7 cells stimulated with H₂O₂ for 3 h (A) and 24 h (B) as described in example 4. Unstimulated cells are used as control.

FIG. 6 shows the profile of activated transcription factors in MCF7 cells stimulated with β-estradiol for 4 h (A) and 24 h (B) as described in example 5. Unstimulated cells are used as control.

Table 1 presents the list of genes whose expression level (shown by the expression ratio) significantly changes in U937 cells within the time frame of stimulation with IFNγ as described in examples 1 and 2.

Table 2 presents the list of genes whose expression level (shown by the expression ratio) significantly changes in U937 cells after a 24 h stimulation with IFNα or IFNγ as described in example 3. *genes for which the expression ratio after IFNγ stimulation was either qualitative or quantitative when a confidence interval of 90% rather than the normal 95% is considered.

Table 3 presents the list of genes whose expression level (shown by the expression ratio) significantly changes in MCF7 cells after a 24 h stimulation with H₂O₂ as described in example 4.

Table 4 presents the list of genes whose expression level (shown by the expression ratio) significantly changes in MCF7 cells after a 24 h stimulation with β-estradiol as described in example 5.

In these tables, an expression ratio higher than 1 means that the genes are over-expressed and an expression ratio lower than 1 means that the genes are down-expressed.

### DEFINITION

Unless otherwise defined, all technical and scientific terms used herein have the same meaning as commonly understood by one person ordinary skilled in the art to which this invention belongs.

The terms “biological, physical and/or chemical stimulus” means any parameter (pH, t°, pressure, salinity, UV or ion beam radiation, . . . ), addition or suppression to the cell of any compound (ion, metal, protein, microorganism, drug, . . . ) that may modify the cell characteristics, or cell modification over time (aging, stress, necrosis, apoptosis, cell transformation or cancerous cell, (stem) cell differentiation).

The terms “expressed genes” are those regions of the genomic DNA which are transcribed into mRNA and optionally then translated thereafter into (poly-) peptides or proteins.

The terms “nucleic acid, array, target nucleic acid, bind substantially, hybridizing specifically to, background, quantifying” are as described in WO97/27317, which is incorporated herein by way of reference.

“Micro-arrays and arrays” mean supports on which single capture molecules or capture probes species are immobilized in order to be able to bind to the given specific protein or target. The most common arrays are composed of single capture probes species being present in predetermined locations of a support being or not a substrate for their binding. The array is preferentially composed of spots of capture molecules deposited at a given location on the surface or within the support or on the substrate covering the support. The capture probes are present on the support in various forms being but not limited to spots. One particular form of application of array is the presence of capture probes in wells having either one of several different capture probes per well and being part of the same support. In one particular application of this invention, arrays of capture molecules are also provided on different supports as long as the different supports contain specific capture molecules and may be distinguished from each other in order to be able to quantify the specific target. This can be achieved by using a mixture of beads having particular features and being able to be recognized from each other in order to quantify the bound molecules.

The terms “capture probe” and “capture molecule” relate_ to a molecule capable to specifically bind to a given polynucleotide or polypeptide. Polynucleotide binding is obtained through base pairing between two polynucleotides, one being the immobilized capture probe and the other one the target to be detected.

Capture probes for transcriptional factors also include nucleotide sequences to which the transcriptional factors will bind.

The term “single capture probe species” is a composition of related polynucleotides or polypeptides for the detection of a given sequence by base pairing hybridization or by molecular recognition between polypeptides or proteins. Polynucleotides or polypeptides are synthesized either chemically or enzymatically or purified from samples but the synthesis or purification is not always perfect and the capture molecule is contaminated by other related molecules like shorter polynucleotides or other polypeptides. The essential characteristic of one capture species for the invention is that the overall species can be used for capture of a given target molecule being another polynucleotide or polypeptide sequence.

As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, or pieces of them, are all derived from the mRNA transcript; the detection of such derived products is indicative of the presence and/or abundance of the original transcript in a sample. Thus, suitable samples include, but are not limited to, mRNA transcripts of the genes, cDNA reverse transcribed from the mRNA, cRNA transcribed from the cDNA, DNA amplified from the genes, RNA transcribed from amplified DNA, and the like or pieces of them.

The “hybridized nucleic acids” are typically detected by detecting one or more “labels” attached to the sample nucleic acids. The labels may be incorporated by any of a number of means well known to those skilled in the art, such as detailed in WO 99/32660, which is incorporated herein by way of reference.

The terms “Transcriptional factors” or “transcription factors” both refer indifferently to proteins which bind to specific sequences of double stranded DNA, called consensus sequences, and when activated either by themselves or with the help of other proteins or enzymes will modulate, either activate or repress, the transcription of the DNA. They are composed of a DNA binding domain and a transactivating domain responsible for their activity and they are part of a large protein complex which interacts with the transcriptional machinery for regulating its activity. Some Transcriptional factors are able to bind single stranded DNA as for example the class of single-stranded DNA binding transcription factors belonging to the Y-box family of protein which influence transcription of both cellular and viral genes (Swamynathan, S. K., Nambiar, A., Guntaka, R. V. FASEB J. 12, 515-522 (1998).

“Protein phosphorylation” refers to post-translational protein phosphorylation. “Phosphorylation” includes phosphorylation on a protein residue being a tyrosine, serine, threonine and/or histidine. Antibodies that can be used to detect these modifications include phosphotyrosine-specific antibody, phosphoserine-specific antibody, and phospho-threonine-proline antibody, for example. Antibodies that may be used to detect these modifications also include antibodies specific to (a) phosphorylated residue(s) of a protein, or a fragment of the protein containing the phosphorylated residue(s). Quantitative determination of the level of phosphorylation is preferably applied to specific kinase and phosphatase residues acting on the same activation pathway or on the same target proteins of a specific activation pathway. The level of phosphorylation of the kinase/phosphatase is then converted into their level of activity and the ratio between the two kinase and phosphatase activities is an estimation of the cell activation level.

“MAP-kinases or Mitogen-activated protein kinases (MAPKs)” is a family of kinases which regulate cell response. MAP-kinase cascades control changes in gene expression, cytoskeletal organization, and cell division.

As used herein, the term “receptor” refers to a protein associated with a cellular membrane and binding to one or more specific molecules (or ligand) only. Receptors may be naturally-occurring or synthetic molecules. Based on their signal transduction mechanisms they may be classified in four groups: (i) receptors that are ligand-gated ion channels (LGIC), e.g., the nicotinic acetylcholine and gamma-aminobutyric acid (GABA) receptors; (ii) receptors that are associated with an enzymatic activity, e.g. the insulin receptor (a tyrosine kinase) or the atrial natriuretic peptide receptor, (a form of a guanylate cyclase); (iii) receptors, that couple to guanosine triphosphate (GTP)-binding proteins (GPCR receptors), e.g., muscarinic acetylcholine receptors; and (iv) receptors with unknown signal transduction mechanisms (e.g., the sigma receptor).

The term “miRNA” is a non coding small RNA produced by a DICR enzyme from a double stranded RNA precursor. The precursor has a stem loop or hair-pin structure. miRNA are present in animals or plants. They are mainly bound to a protein complex termed miRISCs. They represent one of the components of the RNAi beside other ones like the siRNA. miRNAs regulate mRNA translation whereas siRNAs direct RNA destruction via the RNA interference pathway. miRNAs are processed through at least two sequential steps; generation of 70 nucleotides (pre-miRNAs) from the longer transcripts (termed pri-miRNAs) and processing of pre-miRNAs into mature miRNAs (Lee et al. Embo J. 21 (2002), 4663-4670). miRNAs are typically 20-22 nucleotides non coding RNA that regulate expression of mRNA exhibiting sequences complementary thereto. They are numerous and widespread among eukaryotes, being conserved throughout evolution. The actual known number of miRNA is around 250 for human cells.

The term “DNA methylation” refers to a phenomenon occurring on the cytosine bases from DNA. Cytosine exists in a “normal” and in a methylated version (e.g. with a methyl group attached), but only when directly followed by the base guanine. The consequences of methylation lie in the regulation of gene expression: methylated cytosines in the promoter region of a gene lead to inactivation, thus acting as an “on” and “off” switch for genes. This is a naturally occurring mechanism to prevent all genes in a tissue/cell to be expressed at a time.

The term “Chromatin immunoprecipitation” (Chip) refers to a method allowing the identification of targets DNA sequences of transcriptional factors. Cells are fixed to crosslink transcriptional factor proteins to the DNA fragments that they bind in vivo. Cells are lysed, the chromatin is sheared, and the transcriptional factor with its associated DNA is immunoprecipitated. The bound DNA fragments are then recovered, PCR amplified and hybridized on arrays harboring the regulatory regions of the questioned genome. DNA fragments protected by chromatin will give a signal on spots containing sequences complementary to the protected region.

The term “SNP detection” refers to a single nucleotide polymorphism. Correlating the effect of particular single nucleotide polymorphisms (SNP) in DNA sequences to the biology of the system can be obtained on microarray. The array can further provide specific capture probes for detecting particular SNP in specific promoter or genes which may allow understanding of the impact of SNP on the biology of the system.

As used herein, the term “assessing” is intended to include quantitative and qualitative determination in the sense of obtaining an absolute value for the amount or concentration of the analyte present in the sample, and also of obtaining an index, ratio, percentage, visual and/or other value indicative of the level of analyte in the sample. Assessment may be direct or indirect and the chemical species actually detected need not of course to be the analyte itself but may for example be a derivative thereof or some further substance.

“Biological sample” includes a biological fluid or a biological tissue or an extract thereof. Examples of biological fluids include urine, blood, plasma, serum, saliva, semen, stool, sputum, cerebral spinal fluid, tears, mucus, amniotic fluid, cell cultured or the like. Biological tissues are aggregates of cells, usually of a particular kind together with their intercellular substance that form one of the structural materials of a human, animal, plant, bacterial, fungal or viral structure, including connective, epithelium, muscle and nerve tissues. Examples of biological tissues also include organs, tumors, lymph nodes, arteries and individual cell(s).

The term “cell” means any prokaryote or eukaryote cell, preferably a mammal cell, more preferably a human cell which is able to react to an external biological, physical or chemical stimulus. Such cell could be also a tumor cell or a stem cell. The detection and/or quantification of hierarchical (regulated) molecular change of a cell in response to an external biological, physical and/or chemical stimulus is preferably compared with a control cell (or normal cell), which has not been submitted to this stimulus. The characteristics of a cancer cell or of a stem cell could be also compared to a normal cell or to a differentiated cell.

“Cell extracts” are cytoplasmic and/or nucleus elements of a cell submitted to membrane lysis by a chemical, biological or physical means. Detections performed on the same cell extract means assays being done on extracts from the same biological sample. The composition and the method of extraction are adapted for the components to be assayed and are known by the person of the art. A purification step is sometimes required for some components to be assayed.

“A control(led) biological sample” is any biological sample taken as a reference compared to a “test biological sample”. The control biological sample can be derived from a normal tissue and be compared to the test biological sample being for example derived from a diseased tissue. Diseased tissue refers to a pathological condition in an organism resulting e.g., from infection or genetic defect, and is characterized by identifiable symptoms. The control and the test biological samples can be from the same tissue and derived from different organisms, or from the same tissue at different developmental or differentiation stages. The control biological sample can also correspond to untreated cells and the test biological sample to treated cells, wherein the treatment is physical, chemical, physiological or drug administration.

The term “drug” as used herein, should be interpreted broadly to include compounds of known efficacy and safety, drug candidates picked randomly from libraries of compounds or drugs at every levels of investigation. Drugs include compounds which affect the level of activation of cells and could be modulators of kinase/phosphatase activities.

### DETAILED DESCRIPTION OF THE INVENTION

The method of the invention is performed on cell extract being prepared and handled according to the nature of the cell component to be assayed. The cells, tissues or their extracts are separated into 2 or more samples which are then processed as described here below and in the example in order to perform the different specific assays of levels 1 and 2 as proposed in the invention. Thereafter, the data (or results) of the different assays (detection and/or quantification) are re-associated and processed (collected, correlated and integrated as models) according to the invention for characterizing the hierarchical molecular change in the cell and providing as output the functional links between the molecular change of the cell detected and/or quantified in the levels 1 and 2.

The created model of a hierarchical system integrates the differential analysis obtained experimentally in the levels 1 and 2 in a cause to effect manner, with at least one molecular change being detected in level 1 having an effect on at least one molecular change detected in level 2. Thus the model contributes to unravel the molecular change detected in level 2.

The assay comprises a control condition which differs from the analysed sample in that, in the sample, the cells have been exposed to a stimulus, which may be a physiological, pathological, mechanical, chemical, toxic, pharmaceutical stress or temperature. One particular stimulus is the binding of one or more ligand to the receptor(s) of the cell. The detection and/or quantification of hierarchical (regulated) molecular change of a cell in response to an external biological, physical and/or chemical stimulus is preferably obtained by comparing the detection and/or quantification of the cell response to a detection and/or quantification of a control(led) cell which has not been submitted to the stimulus. The biological test sample and the control experimental conditions are preferably analyzed in assays performed on the same support. In the second step of the invention method, the assays are capable of detection of at least 5 and preferably at least 10, 20 or 50 different transcriptional factors and/or kinases but the significant changes observed in the activities in a special cell condition refer sometimes to only one or a few (less than 5) transcriptional factors and/or kinases, preferably MAP-kinases.

The arrays to be used are any conventional “biochip structure” on which corresponding biological samples are incubated. These arrays comprise as capture probes polynucleotide sequences and/or peptide sequences.

Advantageously, each of the different assays is performed on a sample containing less than 100 mg and better less than 10 and even less than 1 mg protein.

The assays, as required by the invention, are preferably performed on the same cell extract incubated in separated assays being physically separated. In the preferred embodiment the different assays are performed on arrays being present in different supports or on the same support.

Furthermore, the step of detecting and optionally quantifying for gene expression in the sample or sample extract by the hybridization of polynucleotides on the array is preferably performed on a single capture nucleotide specie used as capture probe.

Advantageously, the expressed genes or proteins detected and/or quantified are selected among a multiplicity of at least 10, 20, 50 or 100, preferably at least 200 or 500, more preferably at least 1000 genes or proteins, encoded in the genome of the cell.

More specifically, the detection and/or quantification of the expressed genes is preferably obtained by the steps of:
a) obtaining (providing) a cell extract containing a pool of target nucleic acids comprising RNA transcripts of one or more of the said genes, or nucleic acids derived therefrom using said RNA transcripts as templates;
b) hybridizing said pool of target nucleic acids to a microarray of polynucleotide capture probes immobilized on a solid support surface, wherein each different polynucleotide probe is localized at a predetermined location of the said solid support surface and wherein each polynucleotide probe is specific of a target nucleic acid and,
c) detecting and/or quantifying the hybridization of the said nucleic acids to said polynucleotide probes of the microarray and wherein the quantification is proportional to the expression level of the said genes.

In a specific application, the analysis of the transcriptome functions is performed on the DualChip human general as proposed in US 2004/0229225 and on the DualChip breast cancer as proposed in US 2004/0191783. The DualChip human general allows the simultaneous analysis of 202 different genes belonging to 13 vital functions. Each gene detection is performed in triplicates. The value for the presence of each gene is the average of the three values and the mean is calculated together with the standard deviation. Each of the value is then corrected using internal standards which have been added in the analysis in a given concentration. Thereafter, a correction for house keeping genes is also performed as an option for variations within the arrays. This process gives absolute values for the genes present in a test experiment compared to a control condition or to reference sample. Example of such microarray is presented in example 1.

In a preferred embodiment, the quantitative determination of the expression of the multiplicity of genes is performed on genes belonging to or being representative of at least 9 of the vital cellular functions selected from the group consisting of: apoptosis, cell adhesion, cell cycle, growth factors and cytokines, cell signaling, chromosomal processing, DNA repair/synthesis, intermediate metabolism, extracellular matrix, cell structure, protein metabolism, oxidative metabolism, transcription, and house keeping genes, said functions being represented by at least 4 different genes.

Advantageously, the transcriptional profile is provided in the following way. The transcriptional profiling genes are divided into 3 categories being but not limited to the over expressed, repressed and non significantly changed genes when comparing the cell in the studied sample or situation and the reference sample.

Preferably the assay for TF is performed according to US 2004/0185497 and US 2003/0162211. The detection of transcriptional factors or proteins able to bind DNA sequence present in cell lysate (including nuclear lysate) or present in a body fluid has to be very sensitive with less than about 10-12 mole of transcriptional factor to be detected in about 50 micro-liters in an assay and better having a limit of detection lower than 10-14 mole in the assay. Sensitivity of the TF assay has to be sufficient for the detection of transcriptional factors naturally present in cell lysate.

The method also preferably comprises the step of identification of at least one characteristic specific of a given activated transcriptional factor. Some transcriptional factors bind to their consensus DNA sequence without activating the transcriptional machinery. The activation is then associated with one or several specific changes, the most common one being the phosphorylation (or dephosphorylation) at specific amino acid(s) of the protein. An example of such transcriptional factor is CREB, which is only active when phosphorylated.

According to a preferred embodiment, binding of the TF is followed by incubation (and washing) with labelled compounds able to react with said transcriptional factor or with first compound already bound to said TF, preferably (monoclonal) antibodies and second compounds, preferably secondary antibodies directed against the anti-transcriptional factor antibodies or specific hypervariable portions thereof (Fab′, Fab2′, etc.). Said secondary antibodies are preferably labelled with non radioactive markers allowing a detection, preferably by colorimetry, fluorescence, bioluminescence, electroluminescence or precipitation of a metal deposit (such as silver staining as proposed by EP1179180). Other secondary compounds as binding proteins like protein A which bind to antibodies are also an embodiment of the method. Said non radioactive test is preferably based upon a colorimetric assay resulting from a catalytic activity such as enzymatic or chemical reduction of silver cation. If direct method such as mass spectrum analysis is sensitive enough it can be used for direct detection of the bound factor.

The method of the invention can also differentiate the DNA binding of the transcription factor and its activity. This activity is associated with one or several particular characteristics of the factors, the most common one being the phosphorylation at specific locations or the dissociation of inhibitory proteins. By using appropriate antibodies directed against these elements, it is possible to determine the amount of transcriptional factors in their active form. As an example, CREB can bind to its DNA consensus sequence without being active. Its activation results from a specific phosphorylation at a serine group, making the P-CREB. The preferred embodiment of this invention is to perform assay for TF on arrays.

The arrays or similar technology allow the simultaneous detection of different factors present in the same sample, with factors binding to their consensus sequence in the same reacting conditions. Solutions are available for example from Promega (Madison, Wis., USA) for the binding of several factors (Catalogue E3581). Conditions which allow the binding of the factors studied may be optimized by the person skilled in the art.

In particular, the detection and/or the quantification of the different (activated) transcriptional factors is performed by the steps of:
a) obtaining (providing) a cell extract containing (activated) transcriptional factors;
b) contacting the cell extract under conditions allowing the binding of (activated) transcriptional factors with a microarray made of at least 5 capture probes/cm² of the solid support surface, wherein each different capture probe is localized in a predetermined location of the said solid support surface, wherein each probe is specific of an (activated) transcriptional factor and,
c) detecting and/or quantifying signal(s) resulting from the binding of the (activated) transcriptional factors to their corresponding capture probes, and wherein the location of the signal is related to the transcriptional factor identity present in said location.

Preferably, the capture probes for the TF assay are double-stranded DNA sequences immobilized on the solid support surface at a concentration of at least 0.01 micromoles/cm², and these double-stranded DNA sequences comprise a specific sequence able to bind specifically an activated transcriptional factor and wherein the double-stranded DNA sequences are linked to the solid support surface by a spacer having a length of at least 6.8 nm.

More preferably, these double-stranded DNA sequences comprise a spacer of at least about 13.5 nm between the specific sequence and the surface of the solid support. In another preferred embodiment, the capture probes are antibodies bound to the support.

In a particular embodiment, the assay includes the assay of the activity of kinases (preferably the MAP-kinases) involved in cell regulation or activation pathways.

More particularly, activities of the kinases being part of the kinase (MAP-kinase) activation pathways are determined by measurement of the level of phosphorylation of the proteins, enzymes being the substrates of the kinases and phosphatases being part of the pathways or of synthetic peptides in an in vitro assay. The activity can be obtained by calculating the ratio between the level of specific phosphorylation to non-phosphorylated form or to the total enzyme content. The degree of activation of the enzymes is obtained preferably by quantification on the same support, preferably in the form of arrays of the amount of phosphorylated enzymes compared to the total amount of enzymes obtained on a second array incubated with the same cell extract.

Quantitative determination of the different activated kinases is preferably performed by the steps of:
a) obtaining (providing) a cell extract containing activated kinases and phosphatases;
b) determining the equilibrium between the activities of kinase/phosphatase enzymes on proteins participating in signal transduction into cells or by quantitatively determining the level of phosphorylation of cellular proteins participating in signal transduction belonging to a cascade of phosphorylation leading to the activation of at least one transcriptional factor

In a preferred embodiment of the invention, the assay for the kinase activity is realized according to the method described in US 2004/0265938.

In another embodiment, the invention assays for different kinase (MAP-kinase) cascades and the resulting phosphoproteins. Protein phosphorylation occurs on an amino acid residue selected from the group consisting of tyrosine, serine, threonine and histidine.

In still another embodiment, the activities of specific kinase/phosphatase enzymes are determined, which give an overview of the cell's present activation by detection and/or the quantitative phosphorylation level of a variety of different cellular targets of kinases/phosphatases, resulting from the equilibrium between these kinases/phosphatases as provided in US 2004/0265938.

The ratios of phosphorylated level of proteins can be compared to samples of cells being either not or sufficiently activated, so that the experimental values of the ratio provide an evaluation of the cell activation compared to the two extreme cell situations.

The same sample is preferably incubated on two different arrays, the first being used for the quantification of the total proteins captured and the second for the quantification of the phosphorylated proteins, with the ratio between the two quantifications giving the level of activation of the cells. The two arrays may contain a plurality of identical capture molecules for the target proteins to be detected, and the level of target proteins is quantified on one array using detection molecules being specific for each of the proteins and the level of phosphorylation of target proteins is quantified on the other array using detection molecules being specific for the phospho-proteins.

The assay preferably includes one or more of the serine, threonine kinases among but not limited to: MKK1, MKK2, MKK3, MKK3, MKK4, MKK5, MKK6, MKK7, MEKK1, MEKK2, MEKK3, MEKK4, TPL2, ASK1, CK1α, CK1α_like, CK1ε, CK1δ, CK1γ1, CK1γ2, CK1γ3, PAK1, PAK2, PAK3, PAK4, PAK5, PAK6, CASK, CAMKIIβ, CAMKγ, CAMK2A, CAMKIIδ, CAMKIIδ_like, AMPK1_like, AMPKA1, PRKK_like, SNF1_like, STK29, MARK, MARK3, EMK, CHK1, PIM1, PIM2, HUNK, STK33, PKCμ, PKCν, PKD2, CHK2, DMPK, DMPK_like, CDC42BPB, ROCK1, ROCK2, KPM, WARTS, SAST, PKN, PDK1, STK33, TSF1, GAK, IKKe, RAF1, RAF1_like, RIPK1, RIPK3, TAK1, TESK1, TESK2, WNK1, WNK2, WNK3, STK2, NEK3, NEK6, MINK1, MINK2, SPAK, IRE1, IRE1B, PRKR, TPL2, WEE1_like, TOPK, HIPK2, YAK1, GSK3b, DYRK1A, DYRK1B, DYRK2, DYRK3, DYRK4, LCK2, STK9, MOK, CDK8, MSSK1, SRPK1, GLK, TLK1, TLK2, PKL, SAK, PIM1, PIM2, CAMKK, AMPKa1, SNF_like2, MELK, EMK, MYLK, DRAK1; and the tyrosine kinases among but not limited to: CDK210, NKLIAMRE, STK9, P38, P38b, P38g, P38d, ERK1-5, JUNK1-3, JAK1, JAK2, JAK3, TYK2, ZAP70, SYK, LYN, HCK, BLK, LCK, FYN, FGR, SRC, YES1, MATK, CSK, FRK, ARG, ABL, ITK, TEC, BTK, TXK, BMX, FER, FES, TNK1, ACK1, FAK, PYK2;

The external biological stimulus can be a binding of one or more ligands (preferably cytokines) to receptor(s) of the cell.

The molecular change at a first level of the cell function (first assay) also comprises the assay for the detection and/or quantification of at least 5 and preferably 20 different cytokines being present in the sample or cell environment (intracellular or extracellular).

More specifically the detection and/or quantification of the cytokines is performed by (the first assay comprises) the steps of:
(a) obtaining (providing) a cell extract containing a pool of cytokines;
(b) contacting the cell extract under conditions allowing the binding of cytokines with a microarray comprising at least 5 and preferably 20 different capture probes being antibodies immobilised on a solid support surface, wherein each antibody is localised at a predetermined location of the surface wherein each antibody is specific for a corresponding cytokine;
(c) detecting and/or quantifying signals resulting from the binding of the cytokines to the capture probes wherein the location of the signal is related to the cytokine identity (detection and/or quantification) which is present in the said location.

Cytokines are generated by different cells, they act autocrine and paracrine and they may behave pleiotropic as well as redundant and antagonistic. Their ability to control and regulate cell differentiation and growth requires recognition and binding to specific receptors. These receptors are part of cell surface and mediate the cytokine binding event into cytoplasmic signals. Alternate pathways might be triggered by cytokines, as for example the Ras-MEK-ERK signal pathway, also know as MAP-kinase signal transduction cascade. The cytokines are responsible for activation or repression of cell activation.

The different cytokines are preferably assayed by ELISA or on an array by detecting a signal present on specific locations on the array preferably bearing specific antibodies as capture probes, said signal at one location being related to the, presence of one cytokine with the detection of at least 3, preferably at least 5, more preferably at least 10 and even more preferably at least 20 cytokines or receptors among the IL-1a, IL-1b, IL-1 RA, IL-2, IL-4, IL-6, IL-8, IL-10, IL-12 p40, 12 p70, IL-17, TNF-a, TNF-RI, TNF-RII, _{—} IFN-g, GM-CSF, Eotaxin, MIP-1a, MIP-1b, MCP1 and RANTES. In a particular embodiment, the assay also includes the assay for the presence of cytokines in the sample or cell environment as proposed in WO00127611A2.

The method of the invention can further comprise a receptor activation assay which is preferably performed on a receptor that activates kinases selected from the group consisting of serine, threonine or tyrosine kinase enzymes.

A preferred method of receptor activation assay is a luminescent assay reagent used for the analysis of G-protein coupled receptor signaling as described by Stables et al. (1999, Recept. Signal Transduct Res., 19, 395-410).

In brief, the assay is performed as follows. Several reporter gene assays have been described where gene transcription is activated as a consequence of a specific signal transduction event, such as activation of adenylyl cyclase. Reporter genes typically consist of specific responsive elements placed upstream of a minimal promoter, which together control the expression of a readily detectable reporter protein, such as luciferase. The dual glow-signal firefly and Renilla luciferase assay allows the simultaneous measurement of two reporter genes in the same well of a 96-well plate. The assay is used for the simultaneous analysis of agonist activity at two G-protein coupled receptors which signal through activation of the G-protein alpha sub-unit, G alpha S.

The present method also allows the specific determination of the expression status of various subtypes and sub-subtype genes of the GPCR or LGIC receptors regulated by all amine neurotransmitters as provided in US 2005/0053946. The method comprises the step of obtaining nucleic acids from a biological sample and contacting the nucleic acids with a micro-array, containing on specific locations thereon at least one capture probe derived from a gene encoding a receptor for a dopamine, a histamine, a serotonin, an adrenergic and a cholinergic neurotransmitter, and determining the expression profile of said receptors in the biological sample, by evaluating the two dimensional pattern of data present as intensities of spots on the surface of the micro-array, one detected and/or quantified spot being sufficient for obtaining the information on one neurotransmitter subtype.

In a preferred embodiment, the micro-array contains capture probes representing genes encoding at least 3 receptors for dopamine, at least 4 for histamine, at least 7 for serotonin, at least 3 for adrenergic and at least 7 for cholinergic neurotransmitters selected among the group consisting of the following subtypes: dopamine (Drd1a, Drd2, Drd3, Drd4, Drd5), for histamine (Hrh1, Hrh2, Hrh3, Hrh4), for serotonin (Htr1a Htr1b, Htr1d, Htr1e, Htr2a, Htr2b, Htr2c, Htr3A, Htr3B, Htr4, Htr5a, Htr5b, Htr6, Htr7), for adrenergic (ADRA1A, ADRA1B, ADRA1D, ADRA2C, ADRB2), for cholinergic (CHRNA2, CHRNA3, CHRNA4, CHRNA5, CHRNA7, CHRNB1, CHRNB2, CHRNB3, CHRNB4, CHRND, CHRNE, CHRM1, CHRM2, CHRM3, CHRM4, CHRM5) and for the trace amine (TA1, TA2, TA3, TA4, TA6, TA7, TAB, TA9, TA10, TA11, TA12, TA13, TA14, TA15). Some possible subtypes may be commonly detected on the same capture probe.

The invention includes the assays for receptors of tyrosine kinases being not limited to: DDR1, DDR2, ROS, AXL, MER, SKY, MET, RON, RYK, TRKA, TRKB, TRKC, MUSK, CCK4, ALK, ROR1/2, RET, TIE, TEK, FLT3, FGFR1, FGFR2, FGFR3, FGFR4, VEGFR1, VEGFR2, VEGFR3, KIT CSF1R, PDGFRA/B, ERBB2, ERBB3, ERBB4, EGFR, EPHA1, EPHA2, EPHA3, EPHA4, EPHA5, EPHA7, EPHA8, EPHB1, EPHB2, EPHB3, EPHB4, EPHB6, INSR, IGF1R, INSRR, LMR1, LMR2.

In another embodiment, the molecular changes at a first level of the cell function are further determined by submitting the cell extract to an assay (the first assay comprises the steps) for the detection and/or quantification of at least 5 and preferably 50 and even preferably 100 different miRNA or siRNA in the cells.

The method also allows the determination of cellular transcriptional regulation by the simultaneous detection and quantification of multiple miRNAs present in a cell.

The detection and/or quantification of the different miRNA is preferentially performed by (the first assay comprises) the steps of:
a) obtaining (providing) a cell extract containing a pool of miRNA;
b) elongating or copying or ligating said miRNAs Into target labeled polynucleotides;
c) hybridizing the said target labelled polynucleotides to a microarray of polynucleotide capture probes immobilized on a solid support surface, wherein each different polynucleotide is localized at a predetermined location of the said solid support surface and wherein each polynucleotide probe is specific for a corresponding target polynucleotide;
d) detecting and/or quantifying signals resulting from the binding of the target labelled polynucleotides to the polynucleotide probes wherein the location of the signal is related to the miRNA identity (detection and/or quantification) present in the said location.

In a preferred embodiment, the array comprises capture probes represented by polynucleotides having a sequence identical to miRNA. The array may contain capture probes being polynucleotides having a sequence complementary to miRNA.

Preferably, the different capture molecules present on the array cover most and preferably all of the miRNA present in a cell. In another preferred embodiment, the capture molecules allow the binding of the miRNA related to the regulation of the gene of interest in the given application.

In principle, the micro-array contains at least 3 capture probes, e.g. one capture probe associated with a miRNA. Yet, the number of capture probes on the micro-array may be selected according to the need of the skilled person and may contain capture probes for the detection of up to about 5000 different miRNA, e.g. about 100, or 200 or 500 or 1000, or 2000 different miRNA involved in the cell transcriptional regulation.

In a preferred embodiment, to unravel the cellular transcriptional regulation, the pattern of at least 3 miRNAs obtained by the method of the invention is correlated with the activation of TF and the pattern of expression of the regulated genes in the same sample.

In another embodiment, the detection and quantification of the miRNA is performed together with the assay on the expression of the genes and the activation of TF through the detection and quantification of mRNA or proteins in the same sample or on extracts coming from the same biological sample.

The method also allows a determination of cellular transcriptional regulation by simultaneous detection and quantification of multiple DNA methylations, Chromatin protections and Single Nucleotide Polymorphism (SNP) sites in DNA in a cell on an array and by detecting signals present on specific locations on the array, said signals at such locations being related to the presence of a methylation, chromatin protected or SNP sites with the detection of at least 5, preferably at least 20, more preferably at least 100 and even more preferably at least 1000 different methylations, chromatin protected or SNP sites on the array being indicative of a given methylation, chromatin protected or SNP sites modulating cellular transcriptional regulation.

In a preferred embodiment the array comprises capture probes represented by polynucleotides having a sequence identical to the methylation, chromatin protected or SNP sites. In another embodiment, the array contains capture probes being polynucleotides having a sequence complementary to methylation, chromatin protected or SNP site.

Preferably, the SNP are assayed using arrays according to the method described in WO0177372. The DNA sequence for which a SNP is to be assayed is first amplified or copied by consensus primer(s) the copied or amplified sequences are hybridized on the array. SNP are also assayed on array bearing core sequence probes as described in U.S. Pat. No. 6,852,488 by comparison of the target binding affinity on the core sequence compared to the single nucleotide variation of the core probe. In another preferred method, the SNP is detected by a reverse chips process as described in WO0196592.

The preferred embodiment for the chromatin protected assay is the following: cells are fixed to crosslink transcriptional factors proteins to the DNA fragments that that they bind in vivo. Cells are lysed, the chromatin is sheared or digested by nucleases, and the transcriptional factors with its associated DNA are immuno-precipitated. The bound DNA fragments are then recovered, PCR amplified and labelled, then hybridized on arrays harbouring the regulatory regions in the genome. DNA fragments protected by chromatin will give a signal on spots containing sequences complementary to the protected regions.

The preferred embodiment for the SNP detection is to provide amplified sequence and to hybridized them immediately on arrays containing single nucleotide difference at the site of the possible mutation. The SNP detection is preferably performed according to the reverse chips technology as described in EP1290228.

Yet, the number of capture probes on the micro-array may be selected according to the need of the skilled person and may contain capture probes for the detection of up to about 5000 different methylation, chromatin protected or SNP sites, e.g. about 5, or 20 or 100 or 1000 different methylation, chromatin protected or SNP site involved in the cell transcriptional regulation.

In a preferred embodiment, the signal present on a specific location on the array corresponds to a pattern of at least 5, 20, 50 and even 100 methylations, chromatin protected or SNP site's.

To unravel the cellular transcriptional regulation, the pattern of at least 5 methylations, chromatin protected or SNP sites obtained by the method of the invention is incorporated into the model and correlated with the activation of TF and the pattern of expression of the regulated genes in the same sample (e.g. provided by a second array). More particularly, the pattern of at least 3 methylations, chromatin protected or SNP sites is incorporated into the model and correlated with the pattern of expression of the methylation, chromatin protected or SNP site target genes in the same sample (e.g. provided by a second array). The pattern of at least 3 methylations, chromatin protected or SNP site's can be correlated with the pattern of expression of genes having mRNA sequences complementary to the corresponding methylation, chromatin protected or SNP site sequence in the same sample (e.g. provided by a second array). The pattern of at least 3 methylations, chromatin protected or SNP site's obtained by the method of the invention can be correlated with activated transcriptional factors in the same sample.

In another embodiment, the detection and quantification of the methylation, chromatin protected or SNP site is performed together with the assay on the expression of the genes and the TF through the detection and quantification of mRNA or proteins in the same sample or on extracts coming from the same biological sample. The methylation, chromatin protected or SNP site and the genes detection assays can be performed on arrays present on the same support. Comparison is performed between the pattern of methylation, chromatin protected or SNP site present in the sample with the pattern of genes differentially expressed in the same sample and the activated or inactivated TF. Preferably, the arrays are present on different supports.

The level of genes is then related to the presence and amount or identity of the corresponding methylation, chromatin protected or SNP site and to the presence of activated or inactivated TF.

The method according to the invention further comprises a receptor activation assay, preferably a receptor activation assay of a receptor that activates kinases selected from the group consisting of serine, threonine or tyrosine kinase enzymes.

According to a preferred embodiment of the present invention, the first assay of the method further comprises a detection and/or a quantification of at least 5, preferably at least 20 different methylation sites of a DNA sequence, a detection and/or a quantification of chromatin protection assay and/or a detection and/or a quantification of at least 5, preferably at least 20 different signal nucleotide polymorphism sites of a DNA sequence.

Preferably the assay for the detection and/or quantification of proteins encoded by the expressed genes is assayed on a microarray of capture probes immobilized on a solid support surface and wherein the detection and/or quantification of the proteins is determined by a signal resulting from one characteristic specific of the proteins and wherein the signal is quantified. The binding of the protein on the surface of the solid support can be obtained through an epitope of the protein which is recognized by a capture probe being an antibody.

In another embodiment, the signal resulting from one characteristic specific of the proteins is the binding of an antibody against an epitope of the protein, or the proteins are identified by determination of their specific molecular weight, preferably using a MALDI mass spectrometer.

In a particular embodiment, the proteins are digested into peptides before their detection and/or quantification by the mass spectrometer analysis. The identity of the protein is determined from the identification of one or several specific peptides or by the determination of the sequence of one or several of the peptides.

The detection and/or quantification of at least 10 different proteins can be also performed by the proteomic analysis using a 2D gel separation by electrophoresis. The separation is performed according to the molecular weight in one direction and to the isoelectric point in the other direction. The identification of the protein is obtained according to their position in the gel which is dependant on their physical character as the molecular weight and isoelectric point. Quantification is performed by quantification of the spots present on the gel after staining of the gel using colour or fluorescent dyes such as but not limited to Cy3 or Cy5. Proteins are also preferably identified by reaction with specific antibodies after transfer of the protein on a membrane. The proteins are preferably detected and/or quantified after their deposit in the form of array, by Mass spectrometer either by MALDI-MS or MALDI-MS-MS analysis. The proteins are digested by enzymatic digestion and the peptides analyzed and identified by mass spectrometry. Quantification is preferably obtained by the determination of the intensity of the mass spectrum signal using a reference protein as standard.

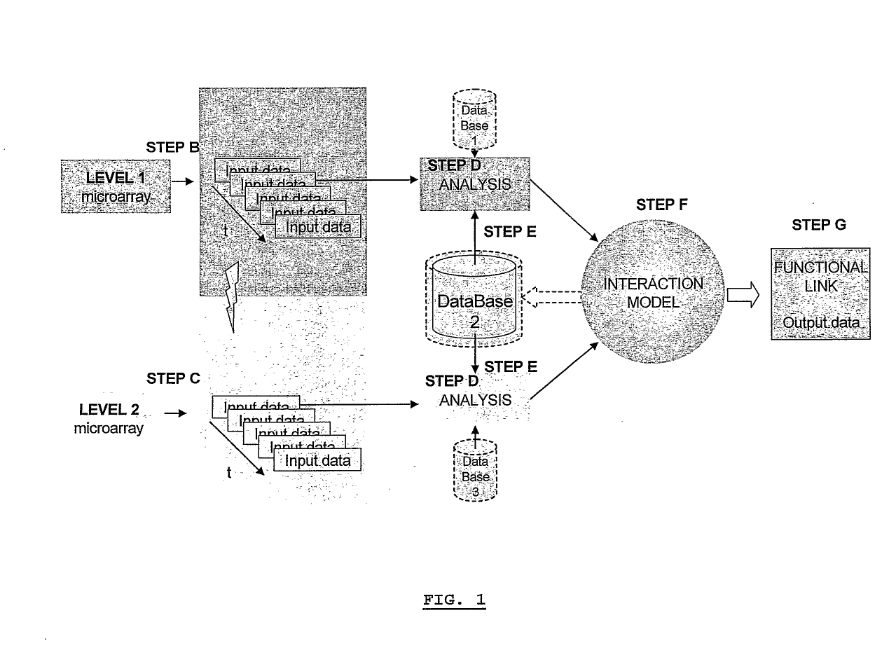

As represented on the FIG. 1, the invention provides a computer system for integrating and correlating the results of detection and/or quantification of hierarchical (regulated) molecular change of a cell in response to an external biological, physical and/or chemical stimulus, and comprising a memory unit, a central processor unit and a storage media containing an executable program for performing the steps e), f), g) and possibly d) of the method according to the invention and comprising the sub steps of receiving input of data (results) of a first and second level of a cell function, constructing from these input data a model response as a representation of interactions between the 2 levels of cell function, wherein said model highlights the regulatory biological process on the second level of the cell function (model of interactions between molecules of the first and the second level).

The computer system can be an Intel Pentium based processor of 166 MHz or more, with a memory unit of 32 MB or more of main memory. The storage media can be for example hard drives, optical drives (CD-ROM, DVD-ROM, DVD-RAM), USB flash medium, DAT tape, ZIP drive, floppy disks of various formats 3.5 inches or 5.25 inches, an Ethernet virtual drive, directly mounted to the computer or remotely connected to said computer system.

The results of detection and/or quantification of the molecules are preferably digitalized images of microarrays, various raw data extracts from the digitalized images of microarrays (which allow a relative quantification of the molecules detected on these microarrays) or are molecules (transcriptional factors, kinases, genes or proteins) relative abundance or profiles. The analysis of the input data of the first level and/or second level is preferentially supplemented by a database input (data bases 1 and 3) providing (relational) information comprising pathways, networks, annotations obtained and collected from scientific papers or literature.

In the preferred embodiment of the invention, the experimental data from level 1 (step B) are completed and confronted by the data base 1 analysis (step D) and the experimental data from level 2 (step C) are completed and confronted by the data base 3 analysis (step D).

In a preferred embodiment, the input of data of the first level of cell function comprises transcriptional factor data related to the activation status of transcriptional factors when comparing the cell in a studied cell extract or situation and a reference cell extract, these data comprising: digitalized image intensities from microarrays, raw data extracted from said images, transcription profile computed from said raw data. The input data (results) of the first level also preferably comprises miRNA relative abundance data and/or activated Kinase data and/or cytokine data and/or SNP sites and/or methylation sites identification. (Step B)

In a preferred embodiment, the input of data (results) of the second level of cell function comprises gene expression data related to the relative abundance of expressed genes (when comparing the cell in the studied cell extract or situation and the reference cell extract, not submitted to the tested stimulus), these data comprising: digitalized image intensities from microarrays, raw data extracted from said images, gene expression profile taking the form of ratio of expression computed from said raw data and pathway response formed based on said ratio. The input data (results) of the second level also preferably comprises synthesized proteins (profiles) relative abundance data. (Step C)

The executable program acquires these input data from a database located on the storage media using a standard computer language for accessing and manipulating databases, for example SQL (Structured Query Language).

Furthermore, these input data (results) coming from the first and second levels may be enhanced (step E) by an additional database (data base 2) comprising validated interaction models between said two levels, previous computed pathway mapping on said regulatory biological processes, said database being grown up by backward-feeding of computed interaction models from previous experiments.

In a particular embodiment, the executable program matches in a first step transcription factor activation profile of the input data to the promoter sequences of regulated genes contained into a database located in said storage media (data base 2) by, but not limited to, SQL queries, and in a second step (step E) correlates these information with gene expression input data. Consensus sequences of the different transcriptional factors are found on the link: http://molsun1.cbrc.aist.go.jp/research/db/TFSEARCH.html. Sequence of the promoters or the genes are part of the genome sequence and are found in data bases such as but not limited to http://www.ncbi.nlm.nih.gov/BLAST/ and http://rulai.cshl.edu/cgi-bin/TRED/tred.cgi?process=searchPromForm.

The executable program constructs a hierarchical model of the effect of the regulatory biological process on the second level by using but not limited, directed network models, K-means, hierarchical clustering, self-organizing maps, neural networks, Bayesian networks, Gaussian graphical models, co-expression networks using conditional independence, graph theory networks. The program runs on a computer. Step E

The model is preferably built by creating a relational network made up of nodes representing entities from said levels and directed or undirected links between said nodes evaluating biological interactions. (Step E)

The relational network is characterized as a random network, scale-free network or hierarchical network depending on the organisation of the nodes and links forming the network. The organisation is inferred from the degree distribution of the nodes defined as for example the probability distribution of the number of links of a single node. (Step E)

The nodes are preferably clustered in subset of nodes connected in a specific wiring diagram such as square lattices, triangles, pentagons. Specific subsets occurring more frequently than randomized ones (designated as motifs) being elementary units of biological networks providing information about the typical local interconnection patterns in said network. (Step E)

The executable program preferably constructs an interaction model between the 2 levels by mapping the pathway response obtained from gene expression and/or protein input data to the regulatory biological process. (Step F)

The program constructs a global model of interactions (step F) between the 2 levels of cell function by processing the input data at once and for example but not limited to computing scores of correlation between the regulatory biological process and the second level. The model response is constructed (step F) as a representation of interactions between the 2 levels using optional complementary information drawn from database 2 containing for example validated relational models or general information on the relationships between the two levels. The resulting constructed model feeds database 2 for further predictive analysis.

Finally, the model determines in an hierarchical manner the functional links between molecular changes of the cell detected and/or quantified in the first level and second level (step G) in the analyzed experimental setting.

In a particular embodiment, the program also incorporates results of molecular detection and/or quantification results which are compared with a database (data base 2) comprising input providing relation information between molecules (especially pathway network or annotations of these molecules present in the patents and scientific papers). Examples of such pathway network or annotations are known binding properties of molecules, known activation properties of molecules, and presence of specific portions in the sequences of nucleotides which could be bound by a specific activating molecule such as a transcriptional factor. (Step F)

Also the program preferably incorporates the data on specific interactions between TFs or between TFs and other molecules such as cofactors, some of these interactions having a positive effect and others a negative effect on a specific TF. Also the program preferably incorporates the name of the TF member when it is part of a larger family, and of its subunit composition, when the TF can be composed of different subunits, such as AP1. Also preferably the program incorporates the resulting effect on a gene having the consensus sequence for several TF being activated or inactivated in the present experimental conditions.

The complex interaction and outcome of the functional link is performed by a software running on a computer given the complexity of signal transduction, the high number of possible hierarchical interactions and the large number of data to be analyzed. (Step F)

Preferably, the model is a graphical model comprising various relational networks made of nodes representing entities of said level (detected and/or quantified molecules) and directed or undirected links between said nodes. (Step F)

Preferably, said relational network comprises random networks, scale-free networks or hierarchical networks depending on the organization of these nodes and links, and the obtained results. (Step F)

More preferably, in the models according to the invention, the nodes are clustered in a subset of nodes connected on a specific diagram, represented by squares, triangles or polygons. Furthermore, these nodes could be annotated with the specific characteristics of the detected and/or quantified molecules. (Step F)

In particular, these characteristics are related to their quantification results, their presence in specific compartments of the cell (nucleus, membranes, chloroplasts, etc). (Step F)

The data (results) obtained from the level 1 and 2 are advantageously expressed over a variable parameter being a concentration of a biological compound exemplified but not limited to cytokines or hormones, a chemical compound as exemplified by a drug, a physical parameter like the temperature, the time frame or a biological parameter being different organisms, the clinical or pathological parameters of the cells, tissues or organisms being studied. One special parameter is the time frame variable. The time frame variable is preferably the time period over which the experiment has been performed and for which data have been obtained at (after) different periods of time. A delay parameter can be introduced to account for response delays between the different levels (layers) of response. Time frame variable provide additional information or possible interactions (links) between molecules of the first level and molecules of the second level, especially for the regulatory process and the feed back going on in the cells considered as a highly regulated system.

In the preferred embodiment, the model is constructed from the data resulting from the detection and/or quantification of molecules (expressed genes, synthesized proteins, activated transcriptional factors, activated kinases, miRNAs and cytokines) relative abundance values or profiles.

In a particular embodiment the data are the results of detection and/or quantification from the analysis of the cell extracts obtained on 4 arrays comprising at least an array on different expressed genes and/or proteins and at least one array on different activated transcriptional factor and/or different activated kinases (MAP-kinase) and at least two arrays on miRNA and/or different methylation sites and/or SNP sites and/or cytokines.

In another embodiment the data are the results of detection and/or quantification from the analysis of the cell extracts obtained on 5 arrays comprising at least an array on different expressed genes and/or protein and at least an array on different activated transcriptional factor and/or different activated kinases (MAP-kinases) and at least two arrays on miRNA and/or different methylation sites and/or SNP sites and/or cytokines.

In one embodiment, a relationship (link) is made between the kinase activation and the TF activation with the transcriptional profiling of the cell (possibly collected in a database connected to a computer).

In another embodiment, the cellular regulation pattern considered as a hierarchical system, includes in the model the information given by the presence of specific cytokines, which transduce through the binding to specific receptors, and is included in the overall description of the kinases/phosphatases activation which in turn act on the TF and finally explain the changes obtained in the gene expression and the protein synthesis.

In still another embodiment, the model incorporates the link between the presence of cytokines, the activation of the kinases and/or the activation of TFs and/or the profiling of the miRNA and the transcriptional profiling.

In another embodiment, the invention includes in its model the relationships between the amount of specific miRNA, the presence of activated TF and the transcriptional profiling of the cell.

In another embodiment, the method of the invention incorporates into the model (from databases) the activation of specific receptors and the presence of drugs, ligands, agonists or antagonists of the receptors.

In one embodiment, the invention provides information on the cell being considered as a system biology.

Alternatively, the method and the kit of the present invention may be used for detecting and/or quantifying hierarchical (regulated) molecular change of a cell in response to an external biological, physical and/or chemical stimulus. Proceeding accordingly allows to e.g. elucidate the role of particular genes in a given physiological event or pathological situation, such as stress, aging, stem cell differentiation, haematopoiesis, neuronal functional status, diabetes, obesity, transformation process such as carcinogenesis, protein turnover or circulatory disorders as atherosclerosis infection, neoplasm (neoplasia), cancer, an immune system disease or disorder, a metabolism disease or disorder, a muscle or bone disease or disorder, a nervous system disease or disorder, a signal disease or disorder, or a transporter disease or disorder.

According to a particular embodiment, the invention allows the identification of a key regulatory element responsible for the main molecular changes occurring in the system under a particular stimulus. The change into a key element would mimic the main changes observed under a given stimulus. In particular the method of the invention further comprises the step of modeling the effect of a change occurring in a particular cell component being part of the regulatory system. The invention also predicts the effect on the overall hierarchical model of change in the activity of one of the molecular component being part of the model. Change in a molecular component include but are not limited to the inhibition or activation of enzyme including kinase and phosphatase, of transcriptional factor, of ligand being cytokine or agonist or antagonist being bound to their receptor, of protein/protein interaction forming active or inactive complex, of DNA methylation or acetylation, of the presence of gene specific miRNA or other regulatory mechanism. Preferably this regulatory molecular component is used as (potential) molecular target for drug development.

In one embodiment of this invention, the model allows the prediction of the response of the model (a cell) to perturbation and the possible engineering (of a cell) for industrial or medical purpose. The prediction is then part of the synthetic biology as proposed by Arkin, A. P. 2001 (Sciencedirect (Current opinion in Biotechnology), 2, 638-644) and allows determining potential targets for drug development. In a preferred embodiment, the assay is used for the determination of potential target for drug development or in synthetic biology.

According to still another embodiment the method of the invention further comprises the step of predicting the effect of drug or chemical or biological compound being put in presence of the cell (and acting as a stimulus). Particularly the prediction concerns the main cellular functions such as but not limited to cell cycle or cell division regulation, apoptosis, cell differentiation, DNA repair or synthesis, cell defense, activation of oncogene or antioncogene, tumor suppressor protein activity protease or proteinase, release, lipid metabolism, stress response, cell signaling, protein synthesis.

According to another embodiment, the cells, tissues or organisms are contacted with a substance of interest and the effect of the substance on the status/performance of the cell is monitored. The analysis performed according to the methods described here above allows a quantification of the changes within the cells compared to cells not contacted with the given compound. The invention is particularly useful to follow cellular reactions in the presence of biological or chemical compounds. Variations in the level of transcriptomes, proteomes, TF activation, Kinase activity, miRNA and/or DNA methylation are determined and give an overview of the changes occurring in the biological organisms, cells or tissues, in reaction to the presence of the compound.

The substance efficacy is preferably compared to the chemical structure of the compound in order to detect potential trends into the chemical parameters influencing the cell response to the substance. In another embodiment, compounds activity is evaluated for cell reaction after inhibition of a cell target. Thereafter, specific analysis based on data mining linking the various cellular, pathways and different levels of regulation provides the necessary information on the mechanism behind the presence of the given compound. Substance includes any chemical or biological molecules such as a drug or a molecule to investigate new pathways or as a potential drug. Substances also comprise biological molecules such as cytokines, growth hormones, or any biological molecules affecting cells. It also comprises chemical compounds such as drugs, toxic molecules and compounds from plants or animal extracts, chemicals resulting from organic synthesis including combinatory chemistry.

In one embodiment, cells, tissues or organisms are incubated in particular physical, chemical or biological conditions and the analysis is performed according to the present methods. The particular physical condition means conditions in which a physical parameter has been changed such as pH, temperature, pressure. The particular chemical conditions mean any conditions in which the concentration of one or several chemicals have been changed as compared to a control or reference condition including salts, oxygen, nutriments, proteins, glucides (carbohydrates), and lipids. The particular biological conditions mean any changes in the living cells, tissues or organisms including aging, stress, transformation (cancer), pathology, which affect cells, tissues or organisms.

Therefore, the method as described herein may be utilized as part of a diagnostic and quantification kit which comprises means and media for performing an analysis of biological sample(s) containing target molecules being detected after their binding to the capture probes being present on the support in the form of arrays with a density of at least 5 different capture probes per cm² of surface of rigid support.

According to the invention, the solid support for the array is preferably selected from the group consisting of glass, metallic supports, polymeric supports (preferably a polystyrene support) or any other support used in the microchips (or micro-arrays) technology (preferably activated glass bearing aldehyde or epoxide or acrylate groups), said support comprising also specific coatings, markers or devices (bar codes, electronic devices, etc.) for improving the assay.

If glass presents many advantages (like being inert and having a low auto-fluorescence), other supports like polymers, with various chemically well-defined groups at their surface, allowing the binding of the nucleotide sequences are useful. One of the preferred support is the multi-well plates support including but not restricted to the 96, 384 or even 1536 well plates. In a preferred embodiment, the invention provides arrays in wells being part of multi-well plates having 24, 96 or 394 or even 1536 wells and containing the capture probes specific for performing the assays of the different cell components according to the present invention.

Miniaturization allows performing one assay onto a surface (usually circular spots of about 0.1 to about 1 mm diameter). A low density array, containing 20 to 400 spots is easily obtained with pins of 0.25 mm at low cost. Higher density of spots going to 1,600 spots per cm2 can be obtained by reducing the size of the spots for example to 0.15 mm. Method for obtaining capture molecules of higher density have been described earlier as in U.S. Pat. No. 5,445,934. Miniaturization of the spot size allows obtaining a high number of data which can be obtained and analyzed simultaneously, the possibility to perform replicates and the small amount of biological sample necessary for the assay. Miniaturization for detection on microarrays is preferably associated with microfluidic substrate for separation, extraction of target molecules from the cell extract.

In a preferred embodiment, the assays for gene expression and TF are performed on arrays being on the same support or on different supports from cell extracts coming from the same biological sample. Also in a preferred embodiment, the assays for TFs and/or kinases and possibly miRNA and/or cytokines and/or DNA methylation and/or SNP are performed on arrays being present on the same support or on different supports as the assays for gene expression and/or TF and on cell extract coming from the same biological sample.

In a preferred embodiment, the signal associated with a capture molecule on the array(s) is quantified. The preferred method is the scanning of the array(s) with a scanner being preferentially a laser confocal scanner such as “ScanArray” (Packard, USA) for the detection of fluorescent labeled targets. The preferred detection and/or quantification scanner for colorimetric analysis is performed with the silverquant scanner (Eppendorf, Hamburg, Germany). The resolution of the image is comprised between 1 and 500 μm and preferably between 5 and 50 μm. To Preferably the arrays is scanned at different photomultiplier tube (PMT) settings in order to maximize the dynamic range and the data processed for quantification and corrections with the appropriated controls and standards (de Longueville et al, Biochem Pharmacol. 64, 2002, 137-49).

The presence of target bound on the different capture probes present on the solid support may be analyzed, identified and quantified by an apparatus comprising a detection and quantification device of a signal formed at the location of the binding between the target molecule and the capture molecule, preferably also a reading device of information recorded on a surface of said solid support, a computer program for recognizing the discrete regions bearing the bound target molecules upon its corresponding capture molecules and their locations, preferably also a quantification program of the signal present at the locations and a program for correlating the presence of the signal at these locations with the diagnostic and the quantification of the components to be detected according to the invention.

According to an preferred embodiment the present invention provides a kit detecting and/or quantifying hierarchical (regulated) molecular change of a cell in response to an external biological, physical and/or chemical stimulus, which kit comprises at least 2 microarrays, one microarray for performing the step b) and one microarray for performing the step c) each one having at least 5 different capture probes being arranged at pre-determined locations of a solid support for the assay of the molecular change at first and/or second levels of the cell function, and optionally, buffers and labels.

In a preferred embodiment, the first microarray of the kit is dedicated to the detection and/or quantification of at least 10, 20, 50, 100, 200, 500 or 1000 different expressed genes present in the cell extract and the second microarray is dedicated to the detection and/or quantification of at least 5, 10, 20 or 50 different activated transcriptional factors and/or 5, 10, 20 or 50 different activated Kinases present in the cell extract.

In another embodiment, the first microarray of the kit is dedicated to the detection and/or quantification of at least 10, 20, 50, 100, 200, 500 or 1000 different expressed genes present in the cell extract and the second microarray is dedicated to the detection and/or quantification of at least 5, 10, 20 or 50 different cytokines present in the cell extract.

In an embodiment, the first microarray of the kit is dedicated to the detection and/or quantification of at least 10, 20, 50, 100, 200, 500 or 1000 different expressed genes present in the cell extract and the second microarray is dedicated to the detection and/or quantification of at least 5, 10, 20 or 50 different methylation sites of the DNA in the cell extract.

In one embodiment, the kit also include microarray comprising capture probes for a detection and a quantification of at least 5 different methylation sites and/or 5, 10, 20 or 50 SNP sites of the DNA in the same cell extract.

In a particular embodiment, the capture probes of the two microarrays are of different composition being polynucleotides and polypeptides. In another embodiment the capture probes are of the same composition (the capture probes have the same characteristics) for the detection of transcriptional factors and expressed genes and are polynucleotide sequences.

Preferably, the support provided in the kit contains a plurality of capture molecules capable to specifically bind at least 5 of the proteins as proposed in US 2004/0265938.

The kit also preferably contain reagent and means to perform the determination of cell transcriptional regulation in a sample, which kit comprises an array, harboring capture probes having a sequence identical or complementary to a miRNA or parts thereof and being present at pre-determined locations of the array, and buffers and labels.

The kit also preferably contains reagents and means to perform the evaluation of the activation level of cells by detection and/or quantification of the level of phosphorylation of multiple specific cellular proteins participating in signal transduction in response to a stimulus. The kit preferably comprises at least one support containing a plurality of immobilized capture molecules, said capture molecules being able to specifically bind to both the phosphorylated and non-phosphorylated forms of each cellular protein; two solutions for detection are provided, the first one being able of specifically binding to the phosphorylated target proteins but not to the non phosphorylated target proteins, the second one being able to specifically bind to the non-phosphorylated forms and possibly to the phosphorylated forms of target proteins; means for assessing the level of phosphorylation of said immobilized target proteins. According to a preferred embodiment either or both the capture molecules and the detection molecules are antibodies.

In another embodiment, the two microarrays of the kit are present on the same support or on different supports. In a preferred embodiment, the solid support is a 96 well plate and the different wells are used for performing the different assays of the molecular change at the two levels of cell function.

Preferably the polynucleotides and/or polypeptides are bound to the support at a concentration of at least about 0.01 μmole/cm² of solid support surface; said specific nucleotide sequence are also preferably located at a distance of at least about 6.8 nm (20 nucleotides or higher) from the surface of the solid support.

Another aspect of the present invention is related to a diagnostic kit, including a kit of parts, possibly comprising said computer program or computer program product and comprising means and media for performing the steps b) and c) and possibly the step a) of the method according to the invention, said program is run on a computer. Therefore, all the results obtained from the detection and/or the quantification step, but also from various databases are collected and treated by a computer program which is preferably used for performing the steps e), f) g) and h) and possibly the step d)) of the method according to the invention.

Another aspect of the present invention is related to a computer program comprising a program codes means for performing the steps (steps e, f, g and h) and possibly the step d) of the method according to the invention, when said program is run on a computer.

The present invention is also related to a computer program comprising a program codes means stored on a computer readable medium for performing the steps (steps e, f, g and h) and possibly the step d) of the method according to the invention, when said program is run on a computer.

The kit preferably comprise a storage media with the executable program being preferably in the form of hard drives, optical drives (CD-ROM, DVD-ROM, DVD-RAM), USB flash medium, DAT tape, ZIP drive, floppy disks of various formats 3.5 inches or 5.25 inches, an Ethernet virtual drive, directly mounted to the computer or remotely connected to said computer system.

In another embodiment, the kit contains a software for analysing the relationship between the identification and/or quantification of the miRNA (methylation, chromatin protection, SNP) present in the sample and the level of gene expressed in the same sample. In particular the software allows comparing the sequences of the miRNA with the sequence of the regulated genes.

The kit also preferably contains microarray support for making the assays of gene expression and transcriptional factor and/or kinase activity and possibly miRNA and/or cytokines and/or proteins. Preferably, the support is a glass slide. In another particular embodiment the support is a 24, 96 or 384-well plate with arrays being present in the wells. In another embodiment the multiwell plates which preferably contain 1536 wells contain a single capture probes per well. Preferably one multiwell plate is designed to perform at least 2 different types of assays.

Preferably, the invention is related also to a screening and/or quantification kit or device including high throughput screening device, possibly comprising computer-controllable electromagnetic means, microfluidic device or robots (such as high-throughput screening device) allowing the screening and detection upon any type of solid support and used for the screening and/or quantification of transcriptional factor(s) and of expressed genes present in a biological sample to said solid support bearing nucleotide sequences or polypeptides bound to the insoluble solid support.

### EXAMPLES

The following examples are provided for illustrative purpose only, and are not intended to limit the scope of the invention.

### 1. Hierarchical Molecular Change of a Cell in Response to IFNγ: Analysis of Activated Transcription Factors and Gene Expression Levels on Microarrays Upon Stimulation

### A. Cellular Activation

U937+interferon γ (IFNγ): cells are plated in 75 cm² flasks and grown in RPMI medium supplemented with 10% fetal bovine serum and antibiotics. They are stimulated at 10.10⁶ cells/75 cm² flask with IFNγ (1000 U/ml) for 15 min and 24 h or left untreated.

### B. Transcription Factor (TF) Microarrays

The activation of transcription factors is monitored on microarrays using the TF Chip MAPK kit from Eppendorf (Germany). The arrays contain double stranded DNA molecules as capture probes for the TF binding. The TF Chip MAPK allows the assay of AP1 (c-Jun), STAT1, Elk-1, p53, c-Myc, ATF2, NFATc1 and MEF2.

### C. Detection of Activated Transcription Factors on TF Chip MAPK Microarrays

A blocking step is performed in a Blocking Solution (TF Chip MAPK kit, Eppendorf, Germany) for 1 h at RT, followed by a washing step using the Washing Buffer A (TF Chip MAPK kit, Eppendorf, Germany). The nuclear extracts are prepared as described in WO 01/73115. They are diluted in the Sample Dilution Solution and Binding Solution (TF Chip MAPK kit, Eppendorf, Germany) and contacted with the arrays. Incubation is performed for one hour at room temperature and under agitation at 600 rpm. Samples are removed and microarrays are washed 3 times.

A mix of primary antibodies (Primary Antibody Cocktail; TF Chip MAPK kit, Eppendorf, Germany), each specifically recognizing the activated form of a transcription factor to be detected and diluted in the Primary Antibody Solution (TF Chip MAPK kit, Eppendorf, Germany), is contacted with the microarrays for 1 h at RT, followed by 3 washing steps. Each microarray is then contacted with Cy3-labeled secondary antibodies under indirect light for 45 min at RT, followed by washing.

Hybridization chambers are removed, and slides are rinsed with Washing Buffer B (TF Chip MAPK kit, Eppendorf, Germany) and dried. A fluorescence detection of signals is performed by scanning slides using a laser confocal scanner “ScanArray” (Packard, USA) at a resolution of 10 μm. Signals are analyzed using the TF Chip MAPK Data analysis software.

### D. Gene Expression Microarrays

The DualChip® human RNAi side effect (Eppendorf, Germany) was used for assay of the changes in the gene expression.

The microarray contains, in triplicates, capture probes to analyze the expression of 260 human genes. In order to evaluate the entire experiment, several positive and negative controls (for hybridization and detection) as well as special capture probes for normalization are included. The DualChip® consists of two microarrays on one slide that has already been framed with a hybridization frame.

The instructions provided by the supplier were followed for the hybridization and the analysis of the results.

### E. Analysis of Gene Expression

Total RNA was extracted from cells using the RNAgents kit (Promega) according to the manufacturer's protocol. 10 μg of total RNA sample were mixed with 2 μl oligo(dT)_{12-18 (}0.5 μg/ηl, Roche), 3.5 μl H₂O, and 2 μl of a solution of 6 different synthetic well-defined poly(A+) RNAs. These latter served as internal standards to assist in quantification and estimation of experimental variation introduced during the subsequent steps of analysis. After an incubation of 10 min at 70° C. and 5 min on ice, 9 μl of reaction mix were added. Reaction mix consisted in 4 μl Reverse Transcription Buffer 5× (Gibco BRL), 2 μl of DTT 0.1M, 1 μl RNAsin Ribonuclease Inhibitor (40 U/ml, Promega), and 2 μl of a 10× dNTP mix, made of dATP, dTTP, dGTP (5 mM each, Roche), dCTP (800 μM, Roche), and Biotin-11-dCTP (800 μM, NEN). After 5 min at room temperature, 1.5 μl SuperScript II (200 U/ml, Gibco BRL) was added and incubation was performed at 42° C. for 90 min. Addition of Superscript and incubation were repeated once. The mixture was then placed at 70° C. for 15 min and 1 μl Ribonuclease H (2 U/μl ) was added for 20 min at 37° C. Finally, a 3 min denaturation step was performed at 95° C. The biotinylated cDNA was kept at −20° C.

Hybridization mixture consisted in biotinylated cDNA (the total amount of labeled cDNA), 10 μl HybriBuffer A (Eppendorf, Germany), 40 μl HybriBuffer B (Eppendorf, Germany), 20 μl H₂O, and 10 μl of positive hybridization control.

Hybridization was carried out overnight at 60° C. The micro-arrays were then washed 4 times for 2 min with Unibuffer (Eppendorf, Germany).

The micro-arrays were than incubated for 45 min at room temperature with the Cy3-conjugated IgG Anti biotin (Jackson Immuno Research laboratories, Inc #200-162-096) diluted 1/1000×Conjugate-Cy3 in the blocking reagent and protect from light.

The micro-arrays were washed again 4 times for 2 minutes with+Unibuffer and 2 times for 2 min with distilled water before being dried under a flux of N₂.

The hybridized micro-arrays were scanned using a laser confocal scanner “ScanArray” (Packard, USA) at a resolution of 10 μm. To maximize the dynamic range of the assay the same arrays were scanned at different photomultiplier tube (PMT) settings. After image acquisition, the scanned 16-bit images were imported to the software, ‘ImaGene4.0’ (BioDiscovery, Los Angeles, Calif., USA), which was used to quantify the signal intensities. Data mining and determination of significantly expressed genes in the test compared to the reference arrays were performed according to the method described by Delongueville et al (Biochem. Pharmacol. (2002) 64(1): 137-49). Briefly, the spots intensities were first corrected for the local background and then the ratios between the test and the reference arrays were calculated. To account for the variation in the different experimental steps, the data obtained from different hybridizations were normalized in two ways. First the values were corrected using a factor calculated from the intensity ratios of the internal standard reference and the test sample. The presence of 3 internal standard probes at different locations on the micro-array allows measurement of a local background and evaluation of the micro-array homogeneity, which is going to be considered in the normalization (Schuchhardt et al. (2000) Nucleic Acids Res. 28, E47). However, the internal standard control does not account for the quality of the mRNA samples; therefore a second step of normalization was performed based on the expression levels of housekeeping genes. This process involves calculating the average intensity for a set of housekeeping genes, the expression of which is not expected to vary significantly. The variance of the normalized set of housekeeping genes is used to generate an estimate of expected variance, leading to a predicted confidence interval for testing the significance of the ratios. Ratio outside the 95% confidence interval were determined to be significantly changed by the treatment.

The gene expression ratio is considered as either quantitative or qualitative. Quantitative ratio means that the test and the reference signals are acceptable (not saturated and detected above the background). Qualitative ratio means that either the test or the reference signal is acceptable but the other one is either in the saturation zone or near the background.

F. Analysis of Gene Expression in Relation with the TF Activation

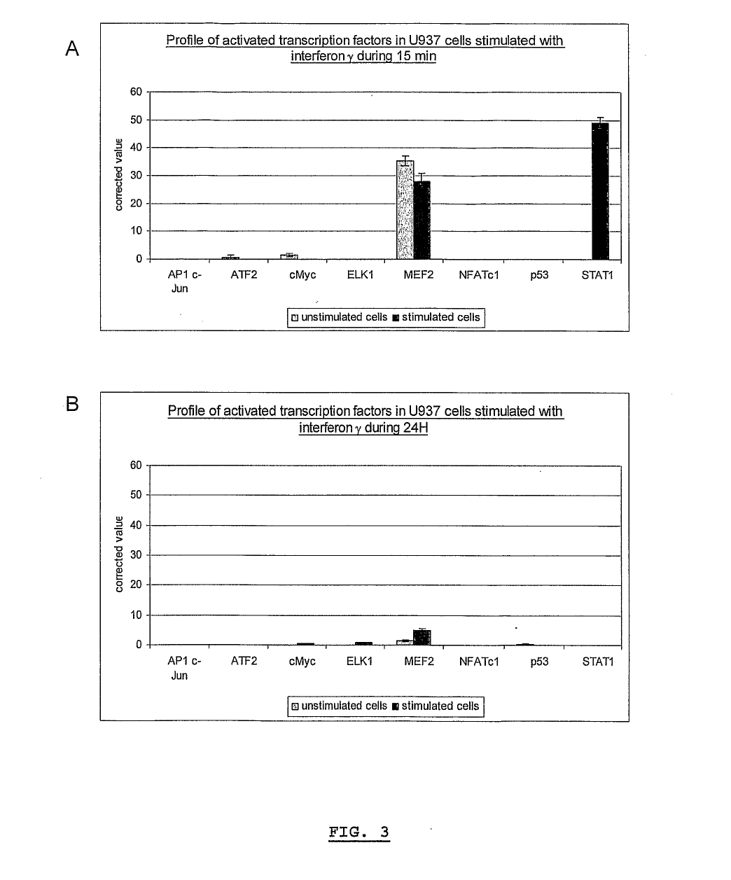

The data obtained on the TF and gene expression microarrays were analyzed as follows. They are presented in FIG. 3 and Table 1.

1. TF Analysis

Only one of the 8 TFs studied using the TF Chip MAPK array (STAT1) was shown to be specifically activated in U937 cells following IFNγ treatment. This was observed for a 15 min activation, in agreement with the early character of the TF activation process in signal transduction. None of the 7 other ones (AP1 (c-Jun), Elk-1, p53, c-Myc, ATF2, NFATc1 and MEF2) were activated. The TF experimental data constitute a first input data bank (step B from FIG. 1). This input data was analyzed using the Pubmed data base (http://www.ncbi.nlm.nih.gov/entrez/query.fcgi) (step D from FIG. 1) to search for possible associations between the 8 TFs from the TF Chip MAPK kit and the IFNγ treatment. The analysis showed that IFNγ stimulation of several cell lines is associated to the activation of TFs other than STAT1 such as c-Jun (e.g. Shibata H et al. (2006) J. Neurosci. Res. 83(1): 102-9), Elk-1 (Choudhury G G (2004) J. Biol. Cell. 279(26): 27399-409), c-Myc and p53 (through many publications). Therefore, the observation that IFNγ only activates STAT1 and not the 7 other TFs in the present experimental conditions was somehow unexpected and could not have been predicted from data base searches only.

2. Gene Expression Analysis

The expression level of 81 genes was found to vary significantly in the experimental conditions of IFNγ stimulation, with most genes varying after 24 h, in agreement with the observation that gene expression is a late event in signal transduction. They are listed in Table 1. The list only refers to the genes whose analysis was quantitative. The experimental data of the analysis constitute a second input data bank (step C in FIG. 1).

These input data were analyzed using the data base of the published paper of PubMed (http://www.ncbi.nlm.nih.gov/entrez/query.fcgi) which was screened for the presence of genes associated to the IFNγ stimulation (step D in FIG. 1). Ten out of the 81 genes identified in this study were not previously reported in the literature as associated to the IFNγ signaling. Conversely, genes present on the microarray and reported in the literature to be regulated by IFNγ, such as BAX (Takeuchi H. et al. (2006) Neurobiol. Dis. 22(1): 33-9) and BCLX (Paiboonsukwong K et al. (2003) Int. J. Hematol. 78(5): 421-8), were not found to be differentially expressed in the present experimental conditions. The list of genes from Table 1 could therefore not have been predicted on the sole basis of data base searches.

3. Combination of TF and Gene Expression Analyses (Step E from FIG. 1)

3.1. Association of IFNγ, the Differentially Expressed Genes and STAT1

From the 81 genes shown to be regulated after IFNγ stimulation, only 13 were already known to be associated with STAT1 through the scientific publications from Pubmed (see Table 1). One reason for this poor association is very likely that these genes are regulated by TFs other than STAT1. However, it is also possible that STAT1 governs the expression of some of these genes through an association which has not yet been reported in the Pubmed data base. To clarify this point, the promoter of the genes from Table 1 was analyzed for the presence of STAT1 binding site(s).

3.2. Analysis of the Gene Promoters

The promoters of the genes were first searched from Table 1 using the Transcriptional regulatory element database (TRED)(http://rulai.cshl.edu/cgi-bin/TRED/tred.cgi?process=home) and were then screened for the presence of a consensus sequence for the binding of all known activated TFs using the TFSEARCH tool (http://molsun1.cbrc.aist.go.jp/research/db/TFSEARCH.html). The gene promoters were found to contain binding sites for numerous TFs, with some promoters containing the binding site for STAT1 and some others not. We will present here under the analysis of 3 genes which exemplifies the different situations which can be found in the particular experimental conditions by using one embodiment of the invention and which could not be deduced by screening the data bank alone.

The following TF binding sites were found in the promoter of CDKN1A: USF, TBP TFIID, TBP, STAT1alpha, STAT2, STATS, STAT4 STAT6, SRY, Sp1, MZF-1, GATA-3, GATA-2, c-Rel, c-Jun, AP-1, AML1a. These sequences include the STAT1 binding site and the gene CDKN1A was already associated to STAT1 (Chin Ye et al. (1996) Science 272(5262):719-22). This example corresponds to the a priori correct situation.

A different situation is observed for the gene encoding Caspase 2, which was not previously associated to STAT1. It contains the following binding elements in its promoter part: TBP TFIID, SRY, Pbx-1a, Oct-6, MZF-1, HSF2, c-Rel, CDP, C/EBPalpha, AP-1. There is no STAT1 binding site in the gene promoter, and the gene was not known to be associated to STAT1. However, caspase 2 is part of our Table 1, and this could not have been deduced from a data base search.

A third example is the gene encoding Caspase 7 which was not known to be associated with the STAT1 TF. It contains the following TF binding elements in its promoter part: USF, STAT1alpha, STAT2, STAT3, STAT4, STATE, SRY, Sp1, p300, MZF-1, GATA-3, GATA-2, EGR3, EGR2, EGR1, E2F E2F-1 E2F-2 E2F-3 E2F-4 E2F-5, c-Rel, AP-1, AML1a. Although the promoter contains a STAT1 binding site, the association between the gene and the TF was not known in the literature.

Out of 81 genes which are differentially expressed by IFNγ in the present experimental conditions, 24 actually contain the consensus binding sequence for STAT1 in their promoter sequence (see Table 1, last column). Combining these genes to those already known to be associated to STAT1 through the Pubmed search (13 in total, see step 3.1) leads to a cluster of 33 genes, among which 4 have the STAT1 binding site in their promoter sequence, were previously reported to be associated to STAT1 and are shown by the present experiment to be differentially expressed in the presence of IFNγ.

Only the combination of the input data from the level 1 (step B, TF analysis on microarray: STAT1), level 2 (step C, gene expression analysis on microarray: 81 genes), and steps D (data base analyses) and E (combination of the data from TF and gene expression) as schematically presented in FIG. 1, can bring the researcher to the solution illustrated by the numbers reported above. Removing one or several of these steps will teach away the researcher from this cluster of genes.

4. Construction of an Interaction Model Determining→Detecting (b)

To construct an interaction model, the genes are classified according to the transduction pathway to which they are usually associated, with 15 genes associated to the interferon response, 6 genes to apoptosis, 3 genes to cell adhesion, 10 genes to cell cycle, 2 genes to cell growth, 5 genes to DNA repair/synthesis, 4 genes to transcription, 3 genes to stress response, 9 genes to metabolism and still some other ones. In particular cases, some genes can not be classified since their function is not known and they are part of a specific class. The genes whose promoter contains the consensus sequence for STAT1 binding were underlined and linked together.

A diagram relating the regulated factor(s) (STAT1 in this example) to a representation of the pathways containing the corresponding sequence is created. Pathway representation is a logical object organizing the pathway structure such as for example maps, matrix or database. Representation of the different pathways can be found for example on the Kyoto Encyclopaedia of Genes and Genomes (KEGG) website at http://www.genome.jp/kegg/. The length of the link is taken to be inversely proportional of the number of statistically significantly regulated genes in the pathway. A representation of each pathway is produced where the regulated genes (including the genes not containing the binding site for the related transcription factor) are highlighted, for example with a color, depending on the strength (ratio) of the regulation. Thus, this diagram clearly expresses the influence of the transcription factor(s) on the different pathways through genes expression regulation. When the interaction is not present in the data base, then they are constructed from the experimental data.

The length of links between genes and regulated factor(s) (STAT1 in this example) are inversely proportional to the expression ratio. The greater the ratio, the shorter the link, which displays the strength of the relation between the genes and TFs. This diagram plots the hierarchical relationship between transcription factors and genes.

In the present experimental situation, this diagram expresses the effect of IFNγ on the transcriptional level and on the gene expression level. It is possible to model the modification of the cellular status triggered by IFNγ.

The diagram is completed by linking the transcription factor(s) to all the genes of the presented pathways containing the related promoter sequence, even if the genes are not tested on the microarray. This permits to complete the model of the relationship between the transcription factors and the pathways.

### 2. Time Frame for IFNγ Stimulation on the Activation of the Cell.

The experimental results from example 1 were analyzed regarding the time frame of IFNγ stimulation.

1. TF Analysis

Briefly, the TF assay shows a fast activation of STAT1 which disappears after 24 h. MEF2 is activated in IFNγ stimulated and non stimulated conditions. MEF2 is sensitive to the handling and to the state of the cells (confluence, low or high concentration of growth factors in culture medium). STAT1 was incorporated into a first data bank, as in example 1 (step B in FIG. 1).

2. Gene Expression Analysis

The gene expression assay shows a large difference in the number and the identity of the genes whose expression is modified after 15 min and 24 h of IFNγ stimulation. The expression of only 4 genes out of 81 was found to be specifically affected by a 15 min IFNγ treatment, while the expression of 72 genes was specifically modified after a 24 h treatment. Five genes were affected by the interferon treatment at the two stimulation times. These sets of genes were incorporated into a second data bank (step C in FIG. 1).

3. Combination of TF and Gene Expression Analyses (Step E in FIG. 1)

As already presented in example 1, we observed 81 genes regulated by IFNγ in a quantitative analysis (Step D from FIG. 1). Among these genes, 24 were associated to both the IFNγ stimulation and to the presence of a STAT1 binding site in their promoter, with 20 specifically affected after 24 h stimulation, 3 specifically affected after 15 min stimulation and 1 affected after both 15 min and 24 h stimulations. On the other hand, 13 genes where previously associated to the IFNγ responsiveness, and only one of them (FOS) was shown to specifically depend upon a fast stimulation in our experimental conditions. Indeed, this gene was shown to be slightly activated after a 15 min IFNγ stimulation, but its expression level returned to a basal level after a 24 h stimulation time. Taken together, these data show that for a 15 min IFNγ stimulation, only one gene (FOS) is differentially expressed, contains a STAT1 binding site in its promoter part and was previously associated to STAT1. For a 24 h IFNγ stimulation, only three genes (ICAM1, CDKN1 and STAT1) are differentially expressed, contains a STAT1 binding site in their promoter part and were previously associated to the TF. These sets of genes were used to form separate clusters.

Based upon the gene expression profile obtained at different time points, the inventors are able to extract groups of genes having similar temporal behavior. Similarity between time course profiles includes different meanings: genes having the same profile and/or genes having the same profile up to a normalization factor and/or genes having inverted profile and/or genes having the same profiles shifted in time. Depending on the definition of the similarity, a clustering method such as directed network models, K-means, hierarchical clustering, self-organizing maps, graph theory networks is used to create subgroups of genes.

At this stage, time course patterns related to group of genes are obtained. The next step is to assign them a biological meaning. This is done either by relating each group to a pathway or a group of pathways from a pathway database and/or by linking them to regulated transcriptional factor using the promoter database as explained in example 1.

Transcription factor activation and gene expression are respectively known as early and late events in the cellular response to stress. This is particularly well exemplified here, as the high STAT1 activation observed after a 15 min interferon treatment disappears after 24 h, while the number of genes which are differentially expressed increases during this time period. The influence of the experimental conditions on the results obtained is also very apparent here, as the numbers obtained by combining input data from experiments and data base searches, as described by the method from the invention, drastically differ if one considers a 15 min or a 24 h interferon stimulation.

Only the combination of the input data from the level 1 (step B, TF analysis on microarray: STAT1), level 2 (step C, gene expression analysis on microarray: 81 genes), and steps D (data base analyses) and E (combination of the data from TF and gene expression) from FIG. 1 can bring the researcher to the solution illustrated by the numbers reported above. Removing one or several of these steps will teach away the researcher from this cluster of genes. Indeed, data base searches will provide similar number of genes regulated by IFNγ through STAT1 binding, no matter the stimulation time. Only the input data provided experimentally can discriminate between the genes affected after the two time periods.

### 3. Comparison of IFNα and IFNγ on the Activation of the Cell.

The experiment was performed as described in example 1 with the cells being stimulated for 15 min and 24 h with IFNγ or IFNα at the same concentration (1000 U/ml).

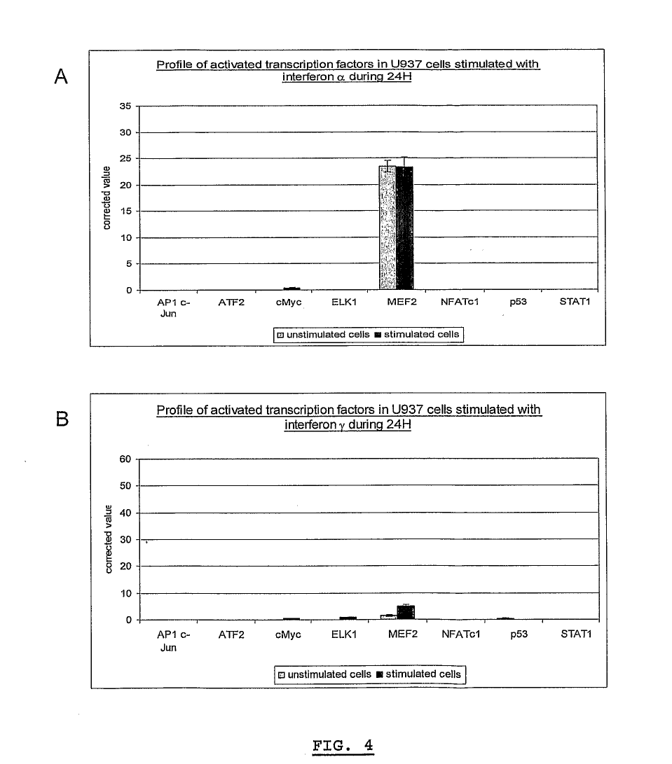

The assays were performed on the TF Chip MAPK kit and on the DualChip® human RNAi side effect (Eppendorf, Germany) as in example 1. The results were analysed as described in example 1 and are presented in FIG. 4 and Table 2. Table 2 presents the ratios for the genes whose values were found quantitative as explained in example 1. However, we investigated further the genes which were found positive for the IFNα response. For these genes, we incorporated into the table the values for the genes determined as quantitative for IFNγ but also the values for two genes, SERPINB2 and IFIT2, which were found qualitative, and the values for 4 other genes for which the ratios were significant when a confidence interval of 90% rather than the normal 95% is considered. These values are presented for sake of completing the information on the comparison between the two treatments and are marked with an asterisk.

1. TF Analysis

The pattern of transcription factor activation is similar when cells are stimulated with either IFNγ or IFNα, with STAT1 being the only TF showing a specific signal in the treated cells after a 15 min stimulation, as illustrated in FIG. 4 (step B from FIG. 1).

2. Gene Expression Analysis

The gene expression pattern was analyzed after 24 h stimulation to take into account the delay between TF activation and gene expression. As for the TF activation pattern, the gene expression pattern shows similarities for the two interferon molecules, with 20 genes having the same gene expression profile from the 89 genes which have statistically significant gene expression values (step C from FIG. 1). The expression of one gene (TFRC) varies for both stimulations, but in an opposite fashion (overexpression upon IFNα stimulation; downexpression upon IFNγ stimulation). 6 genes are exclusively regulated by IFNα, while 62 genes are exclusively associated to IFNγ.

3. Combination of TF and Gene Expression Analyses (Step E from FIG. 1)

The activated TF (in this model, STAT1) was incorporated into a data bank. Then the data base of the published paper of Medline (http://www.ncbi.nlm.nih.gov/entrez/query.fcgi) was screened for the presence of genes already known to be associated with this TF. We found 12 genes already described as associated with the activation by STAT1 from the 89 genes found statistically significant (see Table 2).

The promoters of the 89 genes were screened for the presence of a consensus sequence for the binding of the activated STAT1 using the TFSEARCH engine (http://molsun1.cbrc.aist.go.jp/research/db/TFSEARCH.html). 25 genes where shown to contain a sequence for the binding of STAT1 (see Table 2, last column). Combining the genes which are linked to STAT1 through the literature to those containing a STAT1 binding site in their promoter part leads to a total number of 34 genes which can be considered as associated to STAT1 and regulated by interferon in our experiment.

The results were further analyzed using another data base: the charting pathways from Biocarta (http://www.biocarta.com/genes/allPathways.asp). This data base shows that the signaling cascade triggered by IFNγ (http://www.biocarta.com/pathfiles/h_ifngPathway.asp) is mainly associated to the activation of STAT1αmolecules and their subsequent binding to GAS response elements in the promoter of their target genes. The signaling cascade triggered by IFNα (http://www.biocarta.com/pathfiles/h_ifnaPathway.asp) also involves the activation of STAT1α subunits and their binding to GAS elements, but in addition, IFNα activates STAT2 and p48, which are known to form a ternary complex with STAT1α which binds to ISRE elements. Based on this data base search, we hypothesized that the IFNα stimulation of U937 cells would regulate more genes than IFNγ. The opposite is observed experimentally, however, as only 6 genes are exclusively associated to the IFNα treatment, compared to the 62 genes associated to IFNγ. This result could not have been predicted, and highlights the importance of combining data base searches and experimental inputs to provide information which fit to the unique conditions of the experiment.

4. Construction of an Interaction Model (Step F from FIG. 1)

For both IFNα and IFNγ results, diagrams correlating the activated transcription factors and the gene expression profiles can be created, as explained in example 1. These diagrams depict the regulation by the transcription factors of the gene expression and relate that information to the pathways involved. These diagrams allow matching the modification of the cell status triggered by IFNα and/or IFNγ. This is done by a correlation measure expressing the coincidence between the different models.

4. Hierarchical Molecular Change of a Cell in Response to H₂O₂: Analysis of Activated Transcription Factors and Gene Expression Levels on Microarrays upon Activation.

### A. Cellular Model

In this experiment, the MCF7 breast carcinoma cell line was used as a model. The activation with H₂O₂ was performed by plating the cells in 75 cm² flasks and growing them in RPMI medium supplemented with 10% fetal bovine serum and antibiotics. Cells were stimulated at 80% confluence with 200 μM H₂O₂ for 3 h or 24 h or left untreated as control.

### B. Assays

In this assay, the activated TFs were detected as in example 1 using the TF Chip MAPK kit.

The DualChip® human breast cancer (Eppendorf, Germany) was used to determine gene expression changes in MCF7 cells incubated in the presence of H₂O₂ for 24 h in comparison to control cells. The microarray allows the detection of 210 human genes in triplicates. Hybridizations were carried out in triplicate and the quantification was performed as explained in example 1. The results are presented in Table 3.

1. TF Analysis

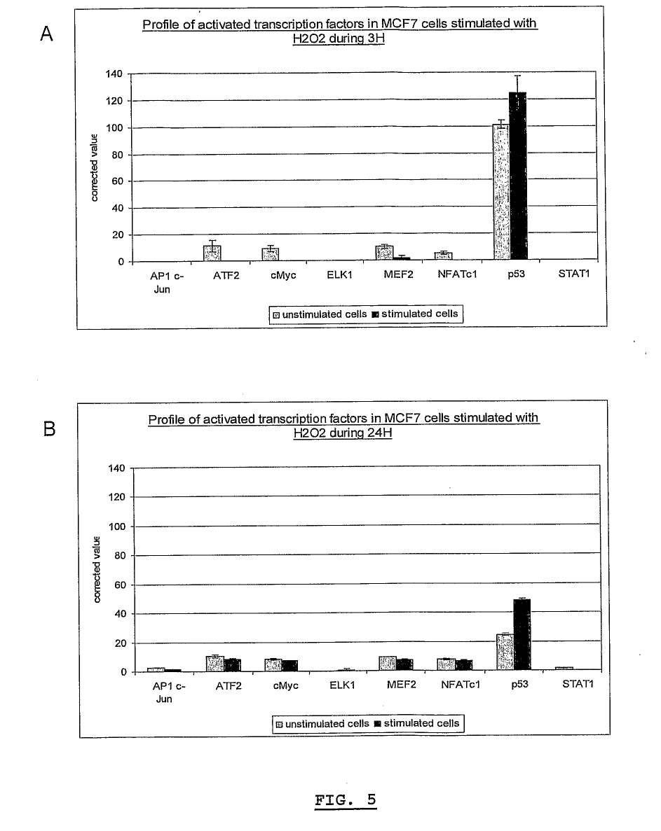

The results of TFs activation are presented in FIG. 5. The stimulation of MCF7 with H₂O₂ shows an activation of p53 after 3 h and 24 h stimulation (FIG. 5; step B from FIG. 1). The activation of ATF2, c-Myc, MEF2 and NFATc1 is suppressed by a 3 h H₂O₂ stimulation and is restored to a basal level (comparable to the level in non treated cells) after a 24 h stimulation. These 5 TFs were incorporated into a first data bank.

The Pubmed data base was searched for possible associations between the 8 TFs from the TF Chip MAPK array and the H₂O₂ treatment (step D from FIG. 1). A tight association is reported between hydrogen peroxide, a well known inducer of apoptosis, and p53, and it is correlated to our experimental data. Some publications report a link between H₂O₂ and c-Jun (i.e. Grosch S & Kaina B (1999) Biochem. Biophys. Res. Commun. 261(3): 859-63), H₂O₂ and Elk-1 (Muller J M et al. (1997) Eur. J. Biochem. 244(1): 45-52) and H₂O₂ and STAT1 (i.e. Yu H M et al. (2006) 11(6): 931-41) although our experimental data did not highlight any modification in the activation state of these 3 TFs. Two publications report an increase in the ATF2 activation upon H₂O₂ treatment, although our experiment showed a decrease. A similar observation was done for c-Myc, MEF2 and NFATc1. These data collected through the data base search therefore show that our results were unexpected and unpredictable.

2. Gene Expression Analysis

The gene expression data are presented in Table 3. The expression level of 16 genes out of 210 is modified after a 24 h treatment with hydrogen peroxide. These genes were incorporated into a second data bank (step C of FIG. 1).

The DualChip human breast cancer allows the detection of 9 genes involved in the apoptotic pathway, but only 2 of them are affected by the hydrogen peroxide treatment in our experimental conditions (BAG and BAX). To establish the correlation of all genes detectable using the DualChip human breast cancer with hydrogen peroxide, a search using the Pubmed data base was performed (step D from FIG. 1).

Five out of the 16 genes from Table 3 (Muc1, MCM7, TOB, NIFU and MPP2) were not previously reported to be regulated by H₂O₂. On the opposite, some genes which are part of the DualChip human breast cancer array and which were not shown experimentally to be regulated by H₂O₂ were associated to this molecule through the data base search. Examples are p53, bcl-x and thrombospondin-1, among many others. The list of genes from Table 3 could therefore not have been predicted using data base analyses.

3. Gene Expression Analysis Correlated to TF Analysis

The analysis was performed as proposed in the preceding examples with matches of the modification of the gene expression status triggered by H₂O₂ combined with the 5 TFs whose activation was modified by the treatment.

The promoter sequence of the 16 genes whose expression is modulated by H₂O₂ (incorporated into the second data bank) was analyzed for the presence of the binding site for the 5 TFs (incorporated into the first data bank) using the TFSEARCH and the TRED data bases. Some genes were not associated to any of the 5 TFs, such as TOB and PPP1CB (Table 3). Others were associated to the 3 TFs whose activation was not modified in our experimental conditions (c-Jun, Elk-1 and STAT1). Therefore, their regulation following the H₂O₂ treatment cannot be explained using the data base searches.

4. Interaction Model (Step F from FIG. 1)

An interaction model was created where all these data were linked. To construct the model, the 16 genes are classified according to the transduction pathway to which they are usually associated, as shown in Table 3. The genes over- and down-expressed are represented in different colors. The genes whose promoter contains consensus sequence(s) for one or several of the 5 TFs from data bank 1 are underlined and linked together. The genes known through literature searches to be associated to one or several of these 5 TFs are also linked together.

A diagram relating the regulated factor(s) to a representation of the pathways containing the corresponding sequence is created. Pathway representation is a logical object organizing the pathway structure such as for example maps, matrix or database. Representation of the different pathways can be found for example on the Kyoto Encyclopaedia of Genes and Genomes (KEGG) website at http://www.genome.jp/kegg/. The length of the link is taken to be inversely proportional of the number of statistically significantly regulated genes in the pathway. A representation of each pathway is produced where the regulated genes (including the genes not containing the binding site for the related transcription factors) are highlighted, for example with a color, depending on the strength (ratio) of the regulation. Thus, this diagram clearly expresses the influence of the transcription factor(s) on the different pathways through genes expression regulation.

The length of links between genes and regulated factors are inversely proportional to the expression ratio. The greater the ratio, the shorter the link, which displays the strength of the relation between the genes and TFs. This diagram plots the hierarchical relationship between transcription factors and genes.

In our example, this diagram expresses the effect of hydrogen peroxide on the transcriptional level and on the gene expression level. It is possible to model the modification of the cellular status triggered by H₂O₂.

The diagram is completed by linking the transcription factors to all the genes of the presented pathways containing the related promoter sequence, even if the genes are not tested on the microarray. This permits to complete the model of the relationship between the transcription factors and the pathways.

5. Hierarchical Molecular Change of a Cell in Response to β-Estradiol: Analysis of Activated Transcription Factors and Gene Expression Levels on Microarrays upon Activation.

### A. Cellular Model

In this experiment, the MCF7 breast carcinoma cell line was used as a model. The activation with β-estradiol (β-E2) was performed by plating the cells in 75 cm² flasks and growing them in RPMI medium supplemented with 10% fetal bovine serum and antibiotics. Cells were stimulated at 80% confluence with 1 μM β-E2 for 4 h or 24 h or left untreated as control.

### B. Assay of Activated Transcription Factors

In this assay, the activated TFs were detected as in example 1 using the TF Chip MAPK kit. The activation of the estradiol receptor alpha (ERα) was also analyzed using a microarray where the double stranded DNA containing the binding site for ERα was spotted.

The assay of ERα was performed as described for the TF Chip MAPK assay (see example 1) with the following differences: the nuclear extracts were diluted in a Hepes buffer supplemented with salt, EDTA, MgCl₂, glycerol, protease and phosphatase inhibitors, and detection was performed using a primary antibody specific for ERα (Santa Cruz, sc-8005).

### C. Gene Expression Assay

In this experiment, The DualChip® human breast cancer (Eppendorf, Germany) was used to determine gene expression changes in MCF7 cells incubated in the presence of β-E2 for 24 h in comparison to control cells. The microarray allows the detection of 210 human genes in triplicates. Hybridizations were carried out in triplicate and the quantification was performed as explained in example 1. The results are presented in Table 4.

1. TF Analysis

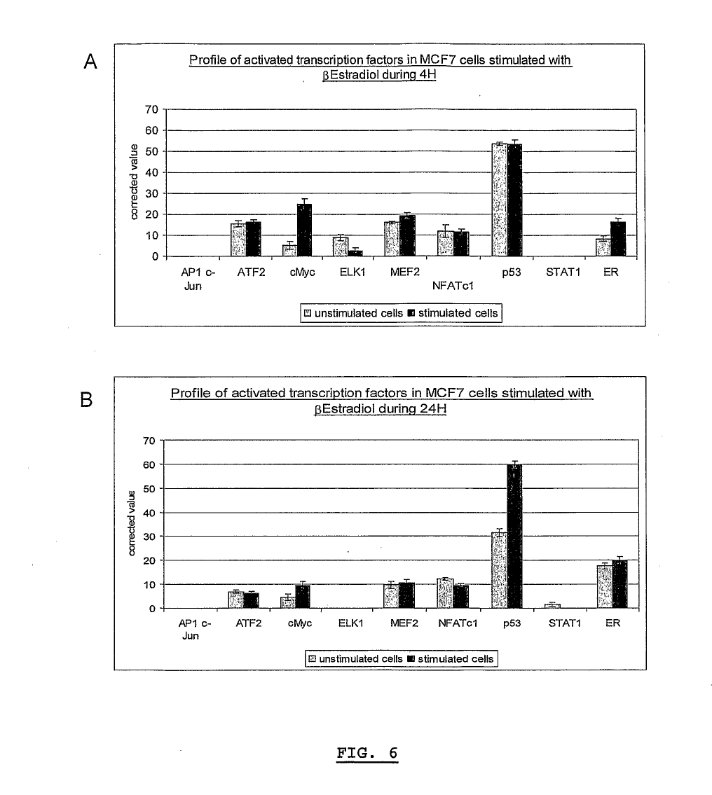

When sub-confluent MCF7 cells are stimulated with β-E2 (FIG. 6), they show a fast activation of ERα and the proliferation marker c-Myc. After 24 h stimulation, cells are confluent. The activation of both transcription factors is reduced while p53, which is highly sensitive to the confluence of the cells, is triggered. These 3 TFs were incorporated into a first data bank: ERα and c-Myc were grouped and separated from p53, which is possibly not associated specifically to the treatment.

The Pubmed data base was searched to look for possible associations between the 8 TFs from the TF Chip MAPK array and the β-E2 treatment (step D from FIG. 1). A tight association is reported between β-E2, ERα and c-Myc, and it is correlated to our experimental data. Some publications associate β-E2 with c-Jun, ATF2, Elk-1 and STAT1 although our experimental data did not highlight any modification in the activation state of these TFs. No association could be found between p-E2 and the 2 other TFs (MEF2 and NFATc1).

2. Gene Expression Analysis

The gene expression data are presented in Table 4. The expression level of 50 genes out of 210 is modified after a 24 h treatment with β-E2. These genes were incorporated into a second data bank (step C of FIG. 1).

To establish the correlation of all genes detectable with β-E2, a search using the Pubmed data base was performed (step D from FIG. 1). 28 out of the 50 genes from Table 4 were not previously reported to be regulated by β-E2. Furthermore, the effect of β-E2 on the level of expression of some genes sometimes differ in our experimental conditions compared to publication reports. As an example, β-E2 was shown by Gompel et al. (Gompel A. et al. (2000) Steroids 6(10-11): 593-8) to increase the antiapoptotic proteins bclx, while we observed the opposite effect. The list of genes from Table 4 could therefore not have been predicted using data base analyses.

3. Gene Expression Analysis Correlated to TF Analysis (Step E from FIG. 1)

The analysis was performed as proposed in the preceding examples with matches of the modification of the gene expression status triggered by β-E2 combined with the 2 TFs whose activation was modified by the treatment (ERα and c-Myc).

The promoter sequence of the 50 genes whose expression is modulated by β-E2 (incorporated into the second data bank) was analyzed for the presence of the binding site for the 2 TFs (incorporated into the first data bank) using the TRED data base. Eight genes contain a binding site for ERα in their promoter part, while 2 genes contain a c-Myc binding site (see Table 4, last 2 columns).

4. Interaction Model (Step F from FIG. 1)

An interaction model is created where all these data are linked. To construct the model, the 50 genes are classified according to the transduction pathway to which they are usually associated, as shown in Table 4. The up- and down-regulated genes are annotated differently. The genes whose promoter contains one or several consensus sequence(s) for the 2 TFs are underlined and linked together. The genes already associated to these TFs through literature searches are also linked.

A diagram relating the regulated factor(s) to a representation of the pathways containing the corresponding sequence is created. Pathway representation is a logical object organizing the pathway structure such as for example maps, matrix or database. Representation of the different pathways can be found for example on the Kyoto Encyclopaedia of Genes and Genomes (KEGG) website at http://www.genome.jp/kegg/. The length of the link is taken to be inversely proportional of the number of statistically significantly regulated genes in the pathway. A representation of each pathway is produced where the regulated genes (including the genes not containing the binding site for the related transcription factors) are highlighted, for example with a color, depending on the strength (ratio) of the regulation. Thus, this diagram clearly expresses the influence of the transcription factor(s) on the different pathways through genes expression regulation.

The length of links between genes and regulated factors are inversely proportional to the expression ratio. The greater the ratio, the shorter the link, which displays the strength of the relation between the genes and TFs. This diagram plots the hierarchical relationship between transcription factors and genes.

In our example, this diagram expresses the effect of hydrogen peroxide on the transcriptional level and on the gene expression level. It is possible to model the modification of the cellular status triggered by β-E2.

The diagram is completed by linking the transcription factors to all the genes of the presented pathways containing the related promoter sequence, even if the genes are not tested on the microarray. This permits to complete the model of the relationship between the transcription factors and the pathways.

6. Hierarchical Molecular Change of a Cell Including the Analysis of a Plurality of miRNA.

The assay for the miRNA detection is preferably performed together with the assay of activated transcription factors and the gene expression assay as provided in the five previous examples.

Assay of miRNA Detection
1. miRNA Isolation

To isolate miRNA fractions, total RNA samples were fractionated and cleaned up with the flashPAGE Fractionator and reagents (Ambion) following the manufacturer's recommendation. Briefly, RNA sample were loaded onto the top of a column filled with a denaturing acrylamide gel matrix and fractionated by applying an electrical current. A dye was loaded with the total RNA sample to track RNAs that are ˜40 nt in size. Electrophoresis was stopped when the dye reached the bottom of the column, and miRNAs were recovered from the bottom buffer chamber using a glass fiber filter-based cleaning procedure (flashPage Reaction CleanUp kit, Ambion).

2. miRNA Labeling and Cleanup

Purified miRNAs were labeled with the mirVana miRNA labeling kit (Ambion) and amine-reactive dyes as recommended by the manufacturer. Poly(A) polymerase and a mixture of unmodified and amine-modified nucleotides were first used to append a poly-nucleotide tail to the 3′ end of each miRNA. The amine-modified miRNAs were then cleaned up and coupled to NHS-ester modified Cy3 dyes (Amersham Bioscience). Unincorporated dyes were removed with a second glass fiber filter-based cleaning procedure.

### 3. Microarray Hybridization and Data Analysis

Fluorescent labelled miRNAs is then hybridized on the microarray “DualChip® human miRNA” bearing ssDNA capture probes specific for 329 mature miRNA sequences (Eppendorf, Hamburg, Germany). Hybridization mixture consisted in 10 μl HybriBuffer A (Eppendorf, Hambourg, Germany), 40 μl HybriBuffer B (Eppendorf, Hambourg, Germany), 22 μl H2O, and 10 μl of positive hybridization control. Hybridization was carried out overnight at 60° C. The micro-arrays were then washed 2 times for 2 min with Wash buffer 1 (B1 0.1×+Tween 0.1%) (Eppendorf, Hamburg, Germany) and 2 times for 2 min with Wash buffer 2 (B1 0.1×) (Eppendorf, Hamburg, Germany) before being dried by centrifugation for 5 min at 600 rpm.

After image acquisition, the scanned 16-bit images are imported to the software, ‘ImaGene 4.0’ (BioDiscovery, Los Angeles, Calif., USA), which is used to quantify the signal intensities. The spots intensities are first corrected by a subtraction of the local background intensity from signal intensity. In order to evaluate the entire experiment, several positive and negative controls are first analysed. Then the signal obtained on each miRNA spots is analysed in order to correlate the result with the presence or not of specific miRNA in the sample.

TABLE 1
IFNγ treatment of U937 cells - Comparison of 15 min and 24 h stimulation

| | | Expression | | | STAT1 | |
|---|---|---|---|---|---|---|
| Gene | | ratio | | | association | STAT1 binding |
| symbol | Gene name | 15 min | 24 H | Pathways | (Pubmed) | site (promoter) |
| BCL2 | B-cell lymphoma2 | / | 0.44 | Apoptosis | x | |
| CASP1 | Caspase1 | / | 2.94 | Apoptosis | x | |
| CASP2 | Caspase2 | / | 2.22 | Apoptosis | | |
| CASP7 | Caspase7 | / | 1.64 | Apoptosis | | x |
| CASP8 | Caspase8 | 0.44 | 1.78 | Apoptosis | | |
| CYCS | Cytochrome c. somatic | / | 0.18 | Apoptosis | | |
| KLK3 | Kallikrein 3. (prostate specific antigen) | / | 1.68 | Carcinogenesis | | |
| CDH13 | Cadherine13. H-cadherin | 4.04 | / | Cell adhesion | | x |
| ICAM1 | Intracellular adhesion molecule1 | / | 3.02 | Cell adhesion | x | x |
| ITGA5 | Integrin alpha5 | / | 0.52 | Cell adhesion | | |
| ATM | Ataxia telangiectasia mutated | / | 1.56 | Cell cycle | | |
| CCND2 | CyclinD2 | / | 0.40 | Cell cycle | | |
| CCND3 | CyclinD3 | / | 2.44 | Cell cycle | | |
| CDK6 | Cyclin-dependent kinase6 | 0.54 | / | Cell cycle | | |
| CDKN1A | Cyclin dependent kinase inhibitor 1A | / | 1.76 | Cell cycle | x | x |
| GRB2 | Growth factor receptor-bound protein2 | 0.60 | 1.61 | Cell cycle | x | |
| MDM2 | MDM2 | / | 3.10 | Cell cycle | x | |
| PCNA | Proliferating cell nuclear antigen | / | 0.44 | Cell cycle | | |
| S100A4 | S100 calcium binding protein A4 | / | 0.52 | Cell cycle | | x |
| S100A8 | Calprotectin/S100 calcium binding | / | 2.14 | Cell cycle | | |
| | protein A8 (calgranulin A) | | | | | |
| IGFBP4 | insulin-like growth factor binding protein 4 | / | 0.42 | Cell growth | | |
| JUN | v-jun sarcoma virus 17 oncogene | / | 0.62 | Cell growth | | |
| | homolog (avian) | | | | | |
| NCK1 | NCK adaptor protein1 | / | 0.40 | Cell signaling/ | | |
| | | | | receptor | | |
| CDC42 | Cell division cycle42 | / | 2.02 | Cell structure | | |
| EMS1 | Ems1 sequence | / | 2.75 | Cell structure | | |
| CENPF | Mitosin. centromere protein F | / | 0.50 | Chromosomal | | x |
| | | | | processing | | |
| HIST1H2BK | histone2b member B/S consensus/ | / | 0.55 | Chromosomal | | |
| | Histone 1. H2bk | | | processing | | |
| PLAU | Plasminogen activator. Urokinase | / | 1.95 | Circulation | x | |
| SERPINE1 | Plasminogen activator inhibitor type1/ | / | 1.78 | Circulation | | |
| | serine proteinase inhibitor. clade | | | | | |
| | E. member 1 | | | | | |
| PRKDC | Protein kinase. DNA-activated. catalytic | / | 0.50 | DNA repair/ | | |
| | polypeptide | | | synthesis | | |
| UNG | Uracil-DNA glycosylase | / | 0.48 | DNA repair/ | | |
| | | | | synthesis | | |
| DDIT3 | DNA-damage-inducible transcript3 | / | 1.89 | DNA repair/ | | |
| | | | | synthesis | | |
| FHIT | Fragile histidine triad gene | / | 1.73 | DNA repair/ | | |
| | | | | synthesis | | |
| TERT | Telomerase-reverse transcriptase | / | 0.30 | DNA repair/ | | |
| | | | | synthesis | | |
| MMP1 | Matrix metalloproteinase 1 | 0.47 | 1.63 | Extracellular matrix | | x |
| MMP11 | Matrix metalloproteinase 11 | / | 2.20 | Extracellular matrix | | |
| MMP7 | Matrix metalloproteinase 7 | / | 0.33 | Extracellular matrix | | |
| TIMP1 | Tissue inhibitor of metalloproteinase1 | / | 0.57 | Extracellular matrix | | |
| TNFSF10 | Tumor necrosis factor (ligand) | / | 2.84 | Growth factor and | | x |
| | superfamily. member 10 | | | cytokine | | |
| GAPD | Glyceraldehyde-3-phosphate | / | 2.36 | HouseKeeping gene | | |
| | dehydrogenase | | | | | |
| HPRT1 | Hypoxanthine phosphoribosyltransferase 1 | / | 3.01 | HouseKeeping gene | | x |
| K-ALPHA-1 | Alpha-tubulin | / | 3.03 | HouseKeeping gene | | |
| RPL13A | Ribosomal protein L13a/23 KDa Highly | / | 3.22 | HouseKeeping gene | | x |
| | basic protein | | | | | |
| TFRC | Transferrin receptor | / | 0.23 | HouseKeeping gene | | |
| YWHAZ | Phospholipase A2/tyrosine3- | / | 3.25 | HouseKeeping gene | | |
| | monooxygenase/tryptophan5- | | | | | |
| | monooxygenase activation protein | | | | | |
| B2M | Beta-2-microglobulin | / | 2.27 | IFN response | | |
| C2 | Complement component 2 | / | 2.66 | IFN response | | x |
| CNP | 2′,3′-cyclic nucleotide 3′ | / | 2.20 | IFN response | | x |
| | phosphodiesterase | | | | | |
| FCER1G | Fc fragment of IgE, high affinity I, | / | 1.82 | IFN response | | x |
| | receptor for; gamma polypeptide | | | | | |
| HLA_C | Major histocompatibility complex. class I, C | / | 2.25 | IFN response | | |
| IFITM1 | Interferon induced transmembrane | / | 52.54 | IFN response | | |
| | protein 1 (9-27) | | | | | |
| IFNAR1 | Interferon (alpha, beta and omega) | 0.45 | 1.91 | IFN response | | |
| | receptor 1 | | | | | |
| IRF1 | Interferon regulatory factor 1 | 1.89 | 5.73 | IFN response | x | |
| JAK2 | Janus kinase 2 (a protein tyrosine kinase) | / | 0.18 | IFN response | x | |
| MYC | V-myc myelocytomatosis viral oncogene | / | 0.52 | IFN response | x | |
| | homolog (avian) | | | | | |
| NYREN18 | NEDD8 ultimate buster-1 | / | 1.49 | IFN response | | x |
| OAS1 | 2′,5′-oligoadenylate synthetase 1, | / | 1.79 | IFN response | | x |
| | 40/46 kDa | | | | | |
| OAS2 | 2′-5′-oligoadenylate synthetase 2, | / | 2.53 | IFN response | | x |
| | 69/71 kDa | | | | | |
| OAS3 | 2′-5′-oligoadenylate synthetase 3, | / | 1.59 | IFN response | | |
| | 100 kDa | | | | | |
| PLA2G1B | Phospholipase A2, group IB (pancreas) | / | 0.22 | IFN response | | |
| ODC1 | Ornithine decarboxylase1 | / | 0.40 | Intermediate | | |
| | | | | metabolism | | |
| ANXA1 | Annexin A1 | / | 1.98 | Lipid metabolism | | |
| CLU | Clusterin/ApoliproteinJ | / | 2.31 | Lipid metabolism | | |
| GSTP1 | Glutathione S-transferase pi | / | 0.44 | Oxidative metabolism | | x |
| SOD2 | Superoxide dismutase2 | / | 2.59 | Oxidative metabolism | | x |
| UBE2L6 | Ubiquitin-conjugating enzyme E2L 6 | / | 5.08 | Parkinson's disease | | x |
| CTSB | CathepsinB | / | 2.97 | Protein metabolism | | |
| WARS | Tryptophanyl-tRNA synthetase | / | 6.02 | Tryptophan | | |
| | | | | metabolism | | |
| CTSL | CathepsinL | / | 1.72 | Protein metabolism | | |
| FOS | c-fos/v-fos FBJ murine osteosarcoma | 1.56 | / | Oncogenesis | x | x |
| | viral oncogene homolog | | | | | |
| HMOX1 | Heme oxygenase 1 | / | 1.84 | Stress response | | |
| HSPCB | Heat shock 90 kDa protein 1, beta | / | 0.45 | Stress response | | |
| PRDX6 | Anti-oxidant-protein2 | / | 1.91 | Stress response | | |
| E2F3 | E2F transcription factor3 | / | 0.42 | Transcription | | |
| EGR1 | Early growth response1 | 1.65 | / | Transcription | | x |
| TFAP2A | Transcription factor AP-2 alpha | / | 1.88 | Transcription | | |
| BCL6 | B-cell CLL/lymphoma 6 (zinc finger | / | 2.51 | Transcription | | |
| | protein 51) | | | | | |
| STAT1 | Signal transducer and activator of | / | 14.25 | Transcription | x | x |
| | transcription 1, 91 kDa | | | | | |
| TAP1 | Transporter 1, ATP-binding cassette, | / | 10.54 | Transport | x | |
| | sub-family B (MDR/TAP) | | | | | |
| BRCA2 | Breast cancer 2, early onset | / | 1.55 | Tumor supressor | | x |
| TGFBR2 | TGF-beta-R2 | / | 1.97 | Tumor supressor | | x |

TABLE 2
Comparison of the IFNα/IFNγ treatment of U937 cells for 24 h (Classification by pathways)

| | | | | | STAT1 | STAT1 |
|---|---|---|---|---|---|---|
| Gene | | Expression ratio | | | association | binding site |
| symbol | Gene name | IFNα | IFNγ | Pathways | (Pubmed) | (promoter) |
| BCL2 | B-cell lymphoma2 | / | 0.44 | Apoptosis | x | |
| CASP1 | caspase 1, apoptosis-related cysteine | 1.60 | 2.94 | Apoptosis | x | |
| | protease (interleukin 1, beta, | | | | | |
| | convertase) | | | | | |
| CASP2 | Caspase2 | / | 2.22 | Apoptosis | | |
| CYCS | Cytochrome c, somatic | / | 0.18 | Apoptosis | | |
| CASP7 | Caspase7 | / | 1.64 | Apoptosis | | x |
| CASP8 | Caspase8 | / | 1.78 | Apoptosis | | |
| KLK3 | Kallikrein 3, (prostate specific antigen) | / | 1.68 | Carcinogenesis | | |
| ICAM1 | Intracellular adhesion molecule1 | / | 3.02 | Cell adhesion | x | x |
| ITGA5 | Integrin alpha5 | / | 0.52 | Cell adhesion | | |
| ITGA6* | Integrin alpha6 | 0.60 | 0.64 | Cell adhesion | | x |
| ATM | Ataxia telangiectasia mutated | / | 1.56 | Cell cycle | | |
| CCND2 | CyclinD2 | / | 0.40 | Cell cycle | | |
| CCND3 | CyclinD3 | / | 2.44 | Cell cycle | | |
| CDKN1A | Cyclin dependent kinase inhibitor 1A | / | 1.76 | Cell cycle | x | x |
| GRB2 | Growth factor receptor-bound protein2 | / | 1.61 | Cell cycle | x | |
| MDM2 | MDM2 | / | 3.10 | Cell cycle | x | |
| PCNA | Proliferating cell nuclear antigen | / | 0.44 | Cell cycle | | |
| S100A4 | S100 calcium binding protein A4 | / | 0.52 | Cell cycle | | x |
| S100A8 | Calprotectin/S100 calcium binding | / | 2.14 | Cell cycle | | |
| | protein A8 (calgranulin A) | | | | | |
| IGFBP4 | insulin-like growth factor binding | / | 0.42 | Cell growth | | |
| | protein 4 | | | | | |
| JUN | v-jun sarcoma virus 17 oncogene | / | 0.62 | Cell growth | | |
| | homolog (avian) | | | | | |
| NCK1 | NCK adaptor protein1 | / | 0.40 | Cell signaling/ | | |
| | | | | receptor | | |
| CDC42 | Cell division cycle42 | / | 2.02 | Cell structure | | |
| EMS1 | Ems1 sequence | / | 2.75 | Cell structure | | |
| CENPF | Mitosin, centromere protein F | / | 0.50 | Chromosomal | | x |
| | | | | processing | | |
| HIST1H4I | Histone4 member M consensus/ | 0.43 | 0.55 | Chromosomal | | |
| | Histone 1, H4i | | | processing | | |
| PLAU | Plasminogen activator, Urokinase | / | 1.95 | Circulation | x | |
| SERPINB2* | Plasminogen activator inhibitor type2/ | 2.96 | 3.05 | Circulation | | |
| | serine proteinase inhibitor, clade | | | | | |
| | B, member 2 | | | | | |
| SERPINE1 | Plasminogen activator inhibitor type1/ | / | 1.78 | Circulation | | |
| | serine proteinase inhibitor, clade | | | | | |
| | E, member 1 | | | | | |
| PRKDC | Protein kinase, DNA-activated, | / | 0.50 | DNA repair/ | | |
| | catalytic polypeptide | | | synthesis | | |
| RAD50 | RAD50 homolog (S. cerevisiae) | 0.16 | / | DNA repair/ | | x |
| | | | | synthesis | | |
| UNG | Uracil-DNA glycosylase | / | 0.48 | DNA repair/ | | |
| | | | | synthesis | | |
| XPA* | Xeroderma pigmentosum, | 0.62 | 0.79 | DNA repair/ | | |
| | complementation group A | | | synthesis | | |
| DDIT3 | DNA-damage-inducible transcript3 | / | 1.89 | DNA repair/ | | |
| | | | | synthesis | | |
| FHIT | Fragile histidine triad gene | / | 1.73 | DNA repair/ | | |
| | | | | synthesis | | |
| TERT | Telomerase-reverse transcriptase | / | 0.30 | DNA repair/ | | |
| | | | | synthesis | | |
| MMP1 | Matrix metalloproteinase 1 | 2.37 | 1.63 | Extracellular matrix | | x |
| MMP11 | Matrix metalloproteinase 11 | / | 2.20 | Extracellular matrix | | |
| MMP7 | Matrix metalloproteinase 7 | / | 0.33 | Extracellular matrix | | |
| TIMP1 | Tissue inhibitor of metalloproteinase1 | / | 0.57 | Extracellular matrix | | |
| TNFSF10 | Tumor necrosis factor (ligand) | / | 2.84 | Growth factors and | | x |
| | superfamily, member 10 | | | cytokines | | |
| IL1B* | Interleukin1 beta | 1.50 | 2.14 | Growth factors and | | |
| | | | | cytokines | | |
| IL8 | Interleukin 8 | 2.26 | / | Growth factors and | | x |
| | | | | cytokines | | |
| VEGFB* | Vascular endothelial growth factor B | 0.80 | 0.79 | Growth factors and | | |
| | | | | cytokines | | |
| GAPD | Glyceraldehyde-3-phosphate | / | 2.36 | HouseKeeping | | |
| | dehydrogenase | | | gene | | |
| HPRT1 | Hypoxanthine | / | 3.01 | HouseKeeping | | x |
| | phosphoribosyltransferase 1 | | | gene | | |
| K-ALPHA-1 | Alpha-tubulin | / | 3.03 | HouseKeeping | | |
| | | | | gene | | |
| RPL13A | Ribosomal protein L13a/23 kDa | / | 3.22 | HouseKeeping | | x |
| | Highly basic protein | | | gene | | |
| TFRC | Transferrin receptor | 1.68 | 0.23 | HouseKeeping | | |
| | | | | gene | | |
| YWHAZ | Phospholipase A2/tyrosine3- | / | 3.25 | HouseKeeping | | |
| | monooxygenase/tryptophan5- | | | gene | | |
| | monooxygenase activation protein | | | | | |
| B2M | Beta-2-microglobulin | 1.54 | 2.27 | IFN response | | |
| C2 | Complement component 2 | / | 2.66 | IFN response | | X |
| CNP | 2′,3′-cyclic nucleotide 3′ | / | 2.20 | IFN response | | X |
| | phosphodiesterase | | | | | |
| FCER1G | Fc fragment of IgE, high affinity I, | / | 1.82 | IFN response | | x |
| | receptor for; gamma polypeptide | | | | | |
| G1P3 | Interferon, alpha-inducible protein | 1.76 | / | IFN response | | |
| | (clone IFI-6-16) | | | | | |
| HLA_C | Major histocompatibility complex, class | 1.72 | 2.25 | IFN response | | |
| | I, C | | | | | |
| IFIT2* | Interferon-induced protein with | 20.68 | 7.42 | IFN response | | |
| | tetratricopeptide repeats 2 | | | | | |
| IFITM1 | Interferon induced transmembrane | 217.25 | 52.54 | IFN response | | |
| | protein 1 (9-27) | | | | | |
| IFITM2 | Interferon induced transmembrane | 1.82 | / | IFN response | | x |
| | protein 2 (1-8D) | | | | | |
| IFNAR1 | Interferon (alpha, beta and omega) | / | 1.91 | IFN response | | |
| | receptor 1 | | | | | |
| IRF1 | Interferon regulatory factor 1 | / | 5.73 | IFN response | x | |
| JAK2 | Janus kinase 2 (a protein tyrosine | / | 0.18 | IFN response | x | |
| | kinase) | | | | | |
| MX1 | Myxovirus (influenza virus) resistance | 1.51 | / | IFN response | | |
| | 1, interferon-inducible protein p78 | | | | | |
| | (mouse) | | | | | |
| MYC | V-myc myelocytomatosis viral | / | 0.52 | IFN response | x | |
| | oncogene homolog (avian) | | | | | |
| NYREN18 | NEDD8 ultimate buster-1 | / | 1.49 | IFN response | | x |
| OAS1 | 2′,5′-oligoadenylate synthetase 1, | 4.98 | 1.79 | IFN response | | x |
| | 40/46 kDa | | | | | |
| OAS2 | 2′-5′-oligoadenylate synthetase 2, | 4.78 | 2.53 | IFN response | | x |
| | 69/71 kDa | | | | | |
| OAS3 | 2′-5′-oligoadenylate synthetase 3, | 2.59 | 1.59 | IFN response | | |
| | 100 kDa | | | | | |
| PLA2G1B | Phospholipase A2, group IB | 0.69 | 0.22 | IFN response | | |
| | (pancreas) | | | | | |
| ODC1 | Ornithine decarboxylase1 | / | 0.40 | Intermediate | | |
| | | | | metabolism | | |
| ANXA1 | Annexin A1 | 2.72 | 1.98 | Lipid metabolism | | |
| CLU | Clusterin/ApoliproteinJ | / | 2.31 | Lipid metabolism | | |
| GSTP1 | Glutathione S-transferase pi | / | 0.44 | Oxidative | | X |
| | | | | metabolism | | |
| SOD2 | Superoxide dismutase2 | / | 2.59 | Oxidative | | x |
| | | | | metabolism | | |
| UBE2L6 | Ubiquitin-conjugating enzyme E2L 6 | 2.90 | 5.08 | Parkinson's disease | | x |
| UBE2C | Ubiquitin conjugating enzyme | 0.64 | / | Protasome | | |
| | E2C/ubiquitin carrier protein | | | | | |
| CTSB | CathepsinB | / | 2.97 | Protein metabolism | | |
| CTSL | CathepsinL | / | 1.72 | Protein metabolism | | |
| HMOX1 | Heme oxygenase 1 | / | 1.84 | Stress response | | |
| HSPCB | Heat shock 90 kDa protein 1, beta | / | 0.45 | Stress response | | |
| PRDX6 | Anti-oxidant-protein2 | / | 1.91 | Stress response | | |
| E2F3 | E2F transcription factor3 | / | 0.42 | Transcription | | |
| TFAP2A | Transcription factor AP-2 alpha | / | 1.88 | Transcription | | |
| BCL6 | B-cell CLL/lymphoma 6 (zinc finger | / | 2.51 | Transcription | | |
| | protein 51) | | | | | |
| STAT1 | Signal transducer and activator of | 4.11 | 14.25 | Transcription | x | x |
| | transcription 1, 91 kDa | | | | | |
| TAP1 | Transporter 1, ATP-binding cassette, | 2.26 | 10.54 | transport | x | |
| | sub-family B (MDR/TAP) | | | | | |
| WARS | Tryptophanyl-tRNA synthetase | / | 6.02 | Tryptophan | | |
| | | | | metabolism | | |
| BRCA2 | Breast cancer 2, early onset | / | 1.55 | Tumor suppressor | | x |
| TGFBR2 | TGF-beta-R2 | / | 1.97 | Tumor supressor | | x |

TABLE 3
MCF7 stimulation with H₂O₂ for 24 h

| | | | | Promoter binding site | | | | | | | |
|---|---|---|---|---|---|---|---|---|---|---|---|
| Gene | | Expression | | | | | NFAT | | | | |
| symbol | Gene name | ratio | Pathways | ATF-2 | c-Myc | MEF2 | c1 | p53 | c-Jun | Elk-1 | STAT1 |
| BAG-1 | BCL-2 associated athanagene | 1.65 | Apoptosis | | | | | xx | x | x | x |
| BAX | BCL2-associated X protein | 1.86 | Apoptosis | | x | | | xx | x | | |
| ODC | Ornithine decarboxylase1 | 0.61 | Arginine synthesis | | | | | | x | | |
| Muc1 | Mucine1, transmembranaire | 1.64 | Cell adhesion | | | | | | x | | x |
| MKi67 | Ki-67 | 0.56 | Cell cycle | | | | | xx | | | |
| MCM7 | minichromosome maintenance | 0.57 | Cell cycle | | xx | | | xx | | x | |
| | deficient 7 (S. cerevisiae) | | | | | | | | | | |
| p21 | Cyclin dependent kinase | 3.26 | Cell cycle | x | | | | xx | x | | x |
| (CDKN1A) | inhibitor 1A | | | | | | | | | | |
| TOB | Transducer of ERBB2, 1 | 1.63 | Cell growth | | | | | | | | |
| STMN1 | Stathmin 1 | 0.54 | Cell motility | x | x | | | xx | | | |
| K-alpha-1 | Alpha-tubulin | 0.63 | HouseKeeping gene | | | | | | x | | |
| PPP1CB | Protein phosphatase 1, | 0.62 | Hydrolase activity | | | | | | | | |
| | catalytic subunit, beta isoform | | | | | | | | | | |
| NIFU | NIFU | 1.53 | Iron ion binding | x | | | | | | | |
| CTSD | Cathepsin D | 1.65 | Metabolism | x | | | | xx | | | |
| MDM2 | MDM2 | 1.73 | Oncogenesis | x | | | | xx | | | |
| FOXM1 | Forkhead box M1 | 0.55 | Protein metabolism | | | | | | x | | |
| MYBL2 | b-myb | 0.53 | Transcription | | x | | | | | | |

x: TFSEARCH data base;
xx: TRED data base

TABLE 4
MCF7 stimulation with β-Estradiol for 24 h - Classification by pathways

| | | | | Promoter | |
|---|---|---|---|---|---|
| | | | | binding | |
| | | Expression | | site | |
| Gene symbol | Gene name | ratio | Pathways | ERα | c-Myc |
| BAG-1 | BCL-2 associated athanagene | 2.38 | Apoptosis | | |
| bclx | BClX | 0.46 | Apoptosis | | |
| PFKP | Phosphofructokinase, platelet | 1.94 | ATP binding | | |
| STAB-1 | Stabilin 1 | 0.41 | Cell adhesion | | |
| Muc1 | Mucine1, transmembranaire | 0.47 | Cell adhesion | | |
| THBS1 | Thrombospondin 1 | 2.78 | Cell adhesion | | |
| Rbl2 | Retinoblastoma-like 2 (p130) | 0.44 | Cell cycle | | |
| CDKN1 | Cyclin dependent kinase inhibitor 1A | 2.05 | Cell cycle | x | |
| KRT18 | Cytokeratin 18 | 1.56 | Cell differentiation | | |
| KRT8 | Cytokeratin 8 | 2.12 | Cell differentiation | | |
| TOB | Transducer of ERBB2, 1 | 1.95 | Cell growth | | |
| VIM | VIM | 1.80 | Cell motility | | |
| ESR2 | Estrogen receptor beta | 0.63 | Cell signaling/receptor | | |
| ESR1 | Estrogen receptor alpha | 0.46 | Cell signaling/receptor | x | |
| PGR | Progesterone receptor | 1.68 | Cell signaling/receptor | x | |
| PAI1 | Plasminogen activator inhibitor type1 | 2.00 | Circulation | x | |
| CEACAM5 | Carcinoembryonic antigen-related cell | 2.15 | Defense system | | x |
| | adhesion molecule 5 | | | | |
| GATA3 | GATA BINDING PROTEIN 3 | 0.53 | Defense system | | |
| TFF1 | Trefoil factor 1 | 2.19 | Defense system | x | |
| ZNF161 | Zinc finger protein 161 | 2.66 | DNA repair/synthesis | | |
| TOP2A | Topoisomerase2-alpha | 2.07 | DNA repair/synthesis | | |
| LUZP1 | KIAA0601 protein | 2.55 | Electron tranporter | | |
| MMP11 | Matrix metalloproteinase 11 | 0.65 | Extracellular matrix | | |
| PAI-RBP1 | PAI-1 mRNA-binding protein | 2.27 | | | |
| FGFR1 | Fibroblast growth factor receptor | 0.65 | Growth factors and | | |
| | | | cytokines | | |
| ACTB | Beta-Actin | 3.40 | HouseKeeping gene | | |
| PLA2 | Phospholipase A2 | 2.24 | HouseKeeping gene | | |
| TFRC | Transferrin receptor | 1.96 | HouseKeeping gene | | |
| k-alpha-1 | Alpha-tubulin | 1.93 | HouseKeeping gene | | |
| CSTA | Cystatin A | 0.31 | Intracellular degradation | x | |
| NIFU | NIFU | 1.58 | Iron ion binding | | |
| CTSB | CathepsinB | 1.96 | Metabolism | | |
| CTSD | CathepsinD | 2.34 | Metabolism | | |
| STARD3 | START domain containing 3 | 1.90 | Metabolism | | |
| VLDLR | Very low density lipoprotein receptor | 2.12 | Neurogenesis | | |
| CTPS | CTP synthase | 1.82 | Oncogenesis | | |
| GRB7 | Growth factor receptor-bound protein 7 | 0.51 | Oncogenesis | | |
| MTMR4 | Myotubularin related protein 4 | 1.54 | Phosphotase activity | | |
| EIF4E | Eukaryotic translation initiation factor | 1.52 | Protein metabolism | | |
| | 4E | | | | |
| SELENBP1 | Selenium binding protein 1 | 0.45 | Receptor activity | | |
| NSEP1 | Nuclease sensitive element binding | 2.14 | Regulation of expression | | |
| | protein 1 | | | | |
| EGFR | V-erb-b2 erythroblastic leukemia viral | 0.41 | Signal transduction | x | |
| | oncogene homolog 2 | | | | |
| CSDA | Cold shock domain protein A | 1.88 | Transcription | | |
| FOXA1 | Forkhead box A1 | 0.42 | Transcription | | |
| STAT1 | signal transducer and activator of | 2.62 | Transcription | | |
| | transcription 1, 91 kDa | | | | |
| NCOA3 | Nuclear receptor coactivator 3 | 2.14 | Transcription | x | |
| ABCG2 | ATP-binding cassette, sub family G | 1.70 | Transport | | |
| | member 2 | | | | |
| COX6C | Cytochrome c oxidase subunit Vic | 2.19 | Transport | | |
| SLC39A6 | LIV-1 protein, estrogen regulated | 3.18 | Transport | | |
| ING1 | Inhibitor of growth family, member 1 | 0.49 | Tumor suppressor | | x |

1. A method for characterizing hierarchical molecular change of a cell in response to an external biological, physical and/or chemical stimulus, by integrating at least a first level of a cell function and a second level of a cell function, the molecules involved in the first level being regulatory molecules interacting with the expression of the molecules of the second level, by the following steps:
a) obtaining a cell extract from the cell;
b) detecting and/or quantifying a molecular cell change at a first level of the cell function by submitting the cell extract to a first assay upon microarray, said first assay capable of obtaining:
a detection and/or a quantification of at least 5 different activated transcriptional factors present in the cell extract and/or,
a detection and/or a quantification of the activity of at least 5 different MAP-kinases;
c) detecting and/or quantifying a molecular cell change at a second level of a cell function, by submitting the same cell extract to a second assay upon microarray, said second assay comprising:
a detection and/or a quantification of at least 10 different expressed genes and/or,
a detection and/or a quantification of at least 10 different corresponding proteins encoded by these expressed genes, wherein the expressed genes and the corresponding synthesized proteins are regulated by the activated transcriptional factors and MAP-kinases of the first level of the cell function,
d) collecting the results of detection and/or quantification of the expressed genes and/or synthesized proteins and the results of the detection and/or the quantification of the activated transcriptional factors and/or activated MAP-kinases;
e) correlating the said results of the detection and/or the quantification of the expressed genes and/or synthesized proteins to the said results of the detection and/or the quantification of the activated transcriptional factors and/or activated MAP-kinases;
f) integrating the results of said detection and/or quantification and their correlation in a model of a hierarchical system, by a computer,
g) characterizing the hierarchical molecular change in the cell resulting from the external biological, physical and/or chemical stimulus that provides the functional links between the molecular change of the cell detected and/or quantified in the first level and second level.

2. The method according to claim 1, wherein the detection and/or quantification of hierarchical molecular change of a cell in response to an external biological, physical and/or chemical stimulus is obtained by comparing the detection and/or quantification of the cell response to a detection and/or quantification of a control cell which has not been submitted to the stimulus.

3. The method according to claim 1, wherein the external biological stimulus is a binding of one or more ligands to receptor (s) of the cell.

4. The method according to claim 1, wherein the expressed genes detected and/or quantified are selected among a multiplicity of at least 100, encoded in the genome of the cell and wherein said detection and/or quantification is obtained by the steps of:
a) obtaining a cell extract containing a pool of target nucleic acids comprising RNA transcripts of one or more of the said genes, or nucleic acids derived therefrom using said RNA transcripts as templates;
b) hybridizing said pool of target nucleic acids to a microarray of polynucleotide capture probes immobilized on a solid support surface, wherein each different polynucleotide is localized at a predetermined location of the said solid support surface and,
c) detecting and/or quantifying the hybridization of the said nucleic acids to said polynucleotide probes of the microarray and wherein the quantification is proportional to the expression level of the said genes.

5. The method according to claim 4, wherein the quantitative determination of the expression of the multiplicity of genes is performed on genes belonging to or being representative of at least 9 of the vital cellular functions selected from the group consisting of: apoptosis, cell adhesion, cell cycle, growth factors and cytokines, cell signaling, chromosomal processing, DNA repair/synthesis, intermediate metabolism, extracellular matrix, cell structure, protein metabolism, oxidative metabolism, transcription, and house keeping genes, said functions being represented by at least 4 different genes.

6. The method according to claim 1, wherein the detection and/or the quantification of the different transcriptional factors is performed by the steps of:
a) obtaining a cell extract containing activated transcriptional factors;
b) contacting the cell extract under conditions allowing the binding of (activated) transcriptional factors with a microarray made of at least 5 capture probes/cm² of the solid support surface, wherein each different capture probe is localized in a predetermined location of the said solid support surface, wherein each capture probe is specific of the corresponding transcriptional factors, and
c) detecting and/or quantifying signal (s) resulting from the binding of the transcriptional factors to their corresponding capture probes, and wherein the location of the signal is related to the transcriptional factor identity present in the said location.

7. The method according to claim 6, wherein the capture probes are double-stranded DNA sequences immobilized on the solid support surface at a concentration of at least 0.01 micromoles/cm², and wherein the double-stranded DNA sequences comprise a specific sequence able to bind specifically a transcriptional factor and wherein the double-stranded DNA sequences are linked to the solid support surface by a spacer having a length of at least 6.8 nm.

8. The method according to claim 1, wherein the quantitative of the activity of the different activated MAP-kinases, is performed by the steps of:
a) obtaining a cell extract containing activated MAP-kinases and phosphatases;
b) determining the equilibrium between the activities of kinase/phosphatase enzymes on proteins participating in signal transduction into cells or by quantitatively determining the level of phosphorylation of cellular proteins participating in signal transduction belonging to a cascade of phosphorylation leading to the activation of at least one transcriptional factor.

9. The method according to claim 1, wherein the first assay further comprises a detection and/or a quantification of at least 5 different miRNA.

10. The method according to claim 9, wherein the detection and/or quantification of the different miRNA is performed by the steps of:
a) obtaining a cell extract containing a pool of miRNA;
b) elongating or copying or ligating said miRNAs into target labeled polynucleotides;
c) hybridizing said target labeled polynucleotides to a microarray of polynucleotide capture probes immobilized on a solid support surface, wherein each different polynucleotide is localized at a predetermined location of the said solid support surface, and wherein each capture probe is specific of a corresponding labelled polynucleotide;
d) detecting and/or quantifying signals resulting from the binding of the target labeled polynucleotides to the polynucleotide probes wherein the location of the signal is related to the miRNA identity (detection and/or quantification) present in the said location.

11. The method according to claim 1, wherein the first assay further comprises a detection and/or a quantification of at least 5 different cytokines.

12. The method according to claim 11, wherein the detection and/or quantification of the cytokines is performed by the steps of:
a) obtaining a cell extract containing a pool of cytokines;
b) contacting the cell extract under conditions allowing the binding of cytokines with a microarray comprising at least 5 different capture probes being antibodies, immobilized on a solid support surface, wherein each different antibody is localised at a predetermined location of the said solid support surface and wherein each antibody is specific of the corresponding cytokine;
c) detecting and/or quantifying signals resulting from the binding of the cytokines to the capture probes wherein the location of the signal is related to the cytokine identity (detection and/or quantification) present in the said location.

13. The method according to claim 1, wherein the first assay further comprises a detection (and/or a quantification) of at least 5 different methylation sites of a DNA sequence, a detection and/or quantification of a chromatin protection assay, and/or a detection and/or a quantification of at least 5 different single nucleotide polymorphisms sites of a DNA sequence.

14. The method according to claim 1, wherein the at least 10 different proteins encoded by the expressed genes are assayed on an microarray of captured probes immobilized on a solid support surface and wherein the detection and/or quantification of the proteins is determined by a signal resulting from one characteristic specific of the proteins and wherein the signal is quantified.

15. The method according to claim 14, wherein the at least 10 different proteins encoded by the expressed genes are assayed after separation in a 2D gel electrophoresis.

16. The method according to claim 14 or 15, wherein the signal resulting from one characteristic specific of the proteins is the binding of an antibody against an epitope of the protein.

17. (canceled)

18. (canceled)

19. The method according to claim 1, which further comprises a receptor activation assay.

20. The method according to claim 1, which further comprises a receptor activation assay of a receptor that activates kinases selected from the group consisting of serine, threonine and tyrosine kinase enzymes.

21. The method according to claim 1, wherein the capture probes present on the array have a density of higher than 20 spots per cm² of the solid support surface.

22. The method according to claim 1, which further comprises a modeling step of identification of key regulatory element responsible for changes occurring under a particular stimulus.

23. The method according to claim 1, wherein the determination and/or quantification of molecular change at first and second levels of cell function are determined by assays performed on microarrays bearing capture probes being of different or the same composition selected from the group consisting of polynucleotides and polypeptides.

24. The method according to claim 1, wherein the determination and/or quantification of molecular change at first and second levels of the cell function are determined by assays performed in wells being part of multi-well plates.

25. The method according to claim 1, wherein the determination and/or quantification of molecular change at first and second levels of cell function are determined by assays performed on beads.

26. The method according to claim 1, wherein the molecular change of a cell in response to an external biological, physical or chemical stimulus are analyzed over a time period.

27. The method according to claim 1, wherein the step e) of correlating the results is obtained by an independent analysis of the two level data and a representation of interactions between said levels, wherein said comparison highlights the regulation of the biological process on said regulated process, wherein the data are the results of detection and/or quantification of the first level and second level molecules relative abundance values or profiles.

28. The method according to claim 1, wherein the step e) of correlating the results is obtained by a comparison of the results with a database, which comprises information related to molecules involved in the first level, as regulatory molecules interacting with the expression of molecules of the second level, wherein the data are the results of detection and/or quantification of the first level and second level molecules relative abundance values or profiles

29. (canceled)

30. The method according to claim 27 or 28, wherein the data are the results of detection and/or quantification obtained from an analysis of the cell extracts upon 4 arrays, comprising at least one array for the detection and/or the quantification of different expressed genes and/or proteins and at least one array for the detection and/or the quantification of different activated transcriptional factor and/or different activated MaP-kinases, and at least one array for the detection and/or the quantification of molecules selected from the group consisting of miRNA and/or different methylation sites and/or SNP sites and/or cytokines.

31. (canceled)

32. The method according to claim 1, wherein the steps e) and f) of integrating the results of the detection, quantification and correlation in a model is obtained by creating a relation network made of nodes representing molecules of the first level and molecules of the second level, and directed and undirected links between these nodes present in patents and scientific papers, describing the interactions between these molecules.

33. The method according to claim 32, wherein the model is a model of interactions between the two levels of cell function constructed by processing the results at once, by computing scores of correlation between the first level and the second level.

34. The method according to claim 32, wherein a delay parameter is introduced between the detection and quantification steps to account for a response delay between levels of a response.

35. The method according to claim 32, wherein the relation network is complemented by data obtained from an additional database comprising data selected from the group consisting of validated interaction models between the two levels, previous computed pathway mapping on known regulatory biological processes and computed interaction models from previous experiments.

36. The method according to claim 32, wherein the relation network is made of random network, scaled-free network or hierarchical network describing on the organisation of the said nodes and links.

37. The method according to claim 32, wherein the executable program constructs a hierarchical model of the effect of the regulatory biological process on the second level by using models and networks selected from the group consisting of directed network models, K-means, hierarchical clustering, self-organizing maps, neural networks, Bayesian networks, Gaussian graphical models, co-expression networks using conditional independence, and graph theory networks.

38. (canceled)

39. The method according to claim 32, wherein the relational network of nodes are clustered in subsets of nodes said nodes representing entities from said levels and directed or undirected links between said nodes evaluating biological interactions and are connected in specific diagrams and represented as squares, triangles, and/or polygons.

40. The method according to claim 1, further comprising the step of detecting a molecular component involved in the first level or second level as a molecular target in the cell for drug development.

41. The method according to claim 1, further comprising the step of modeling the effect of a change in the activity of one of the molecular component selected from the group consisting of a kinase, a phosphatase, a transcriptional factor and a receptor.

42. The method according to claim 41, wherein the change in the activity includes inhibition or activation of the molecular component.

43. The method according to claim 1, further comprising the step of predicting the effect of a drug or a chemical or a biological compound being put in presence of the cell.

44. The method according to claim 1, further comprising the step of predicting by the synthetic biology approach the response of a cell to perturbation and the engineering of a cell for industrial or medical purpose.

45. (canceled)

46. A computer program comprising program code means for performing the steps e), f), g) and h) of the method according to claim 1, wherein said program is run on a computer.

47. A computer program product comprising program code means stored on a computer readable medium for performing the steps e), f), g), and h) of the method according to claim 1, when said program is run on a computer.

48. A kit or device for detecting and/or quantifying hierarchical molecular change of a cell, in response to an external biological, physical and/or chemical stimulus, comprising the computer program or computer program product of claim 46 and at least one microarray for performing the step b) and at least one microarray for performing the step c) of the method according to claim 1, wherein each microarray comprises at least 5 different capture probes being arranged at pre-determined locations of the microarray solid support surface for the assay of molecular change of a first and second level of the cell function.

49. The kit or device according to claim 48, wherein the first microarray comprises capture probes for a detection and/or a quantification of at least 10 different expressed genes present in an extract of the cell and wherein the second microarray comprises capture probes for a detection and/or a quantification of at least 5 different activated transcriptional factors and/or 5 different activated MAP-kinases present in the same cell extract.

50. The kit or device according to claim 48, wherein the first microarray comprises capture probes for a detection and/or a quantification of at least 10 different expressed genes present in an extract of a cell, and wherein the second microarray comprises capture probes for:
a detection and/or a quantification of at least 5 different miRNA present in the same cell extract, or for a detection and/or a quantification of at least 5 different cytokines present in the same cell extract,
a detection and/or a quantification of at least 5 different methylation sites of a DNA sequence or a detection and/or quantification of a chromatin protection assay, or a detection and/or quantification of at least 5 different single nucleotide polymorphisms sites of a DNA sequence present in the same cell extract.

51. (canceled)

52. (canceled)

53. (canceled)

54. (canceled)

55. (canceled)

56. The kit or device according to claim 48, wherein the solid support is a multiple well plate.

57. (canceled)
